(19) United States
(12) Patent Application Publication
(10) Pub. No.: US 2025/0291559 A1
(43) Pub. Date: Sep. 18, 2025

(54) LANGUAGE MODEL-BASED INTERFACE FOR SIMULATION SYSTEMS AND APPLICATIONS

(71) Applicant: NVIDIA Corporation, Santa Clara, CA (US)

(72) Inventors: Hai Loc Lu, San Jose, CA (US); Junliang Ouyang, San Jose, CA (US)

(21) Appl. No.: 18/951,201

(22) Filed: Nov. 18, 2024

Related U.S. Application Data
(60) Provisional application No. 63/566,898, filed on Mar. 18, 2024.

(51) Int. Cl. G06F 8/35; G06F 40/284; G06F 40/40; G06N 20/00

(52) U.S. Cl. CPC G06F 8/35; G06F 40/284; G06F 40/40; G06N 20/00

(57) ABSTRACT

In various examples, a language model may be trained and used as part of an interface for a simulation system. For instance, user inputs may be applied to the language model and the language model may be trained to generate code, make API calls, or perform any other operations to interact with and/or control various aspects of the simulation. In some examples, the language model may generate code for, among other things, creating and/or customizing a virtual environment associated with the simulation. For instance, the generated code may include, but is not limited to, code for rendering the virtual environment, code for rendering and simulating behaviors of virtual agents (e.g., pedestrians, vehicles, animals, etc.) and/or any other objects (e.g., road signs, buildings, trees, etc.) within the virtual environment, code for recreating and simulating real-world events from recorded sensor data, etc.

### CROSS-REFERENCE TO RELATED APPLICATIONS

This application claims the benefit of U.S. Provisional Application No. 63/566,898, filed Mar. 18, 2024, which is incorporated herein by reference in its entirety.

### BACKGROUND

To create and/or manage virtual environments-whether for game development, simulations, or other applications-developers may use user interfaces (e.g., graphical user interfaces) provided by game engines or simulation platforms that allow the developers to interact directly with the environment by dragging and dropping assets, arranging objects, and visually constructing the virtual world. For instance, in some game engines or simulation platforms, developers may use graphical editors to position assets, set up lighting, and define interactions through a visual interface, making it easier to see and adjust changes in real-time. Additionally, or alternatively, developers may write code to control and/or generate the environment. In some instances, writing custom code may offer greater flexibility and automation, especially for more complex or dynamic scenarios. For instance, developers may write scripts for asset placement, creating procedural content, and/or managing interactions and behaviors within the environment.

In some circumstances, creating environments that are visually appealing and realistic requires a higher level of detail. However, building detailed and functional environments using the above-mentioned techniques may be very time consuming, and developers may be required to balance the depth of detail with available time and resources. For instance, developers may spend hundreds—or even thousands—of hours writing software code for simulations, and making changes to the simulation after the code is complete may require an additional investment of time and/or resources. Furthermore, both of the approaches described above—as well as other approaches not specifically mentioned—may require some form of specialized knowledge for interacting with visual editor systems, which may be unintuitive and/or complex.

### SUMMARY

Embodiments of the present disclosure relate to a language model-based interface for simulation systems and applications. Systems and methods are disclosed that may train and use language models (e.g., large language models, vision-language models, etc.) and/or any other machine learning models as part of an interface for simulation systems or any other systems that may render virtual environments. For instance, user inputs (e.g., speech inputs, text inputs, etc.) may be applied to the language models that are trained to generate code, make API calls, or perform any other operations to interact with and/or control various aspects of the simulation. In some examples, the language models may generate code for, among other things, creating and/or customizing a virtual environment associated with the simulation. For instance, the generated code may include, but is not limited to, code for rendering one or more portions of the virtual environment, code for rendering and simulating behaviors of virtual agents (e.g., pedestrians, vehicles, animals, etc.) and/or any other objects (e.g., road signs, buildings, trees, etc.) within the virtual environment, code for recreating and simulating real-world events from recorded sensor data, and/or any other code for generating and/or updating the simulation

In contrast to conventional systems, the systems of the present disclosure, in some embodiments, are able to automatically generate code, make API calls, and perform various operations to render features of a virtual environment based on user inputs representing natural language queries and requests. For instance, by using language models to generate code for rendering features (e.g., terrain, objects, virtual agents, etc.) of a virtual environment, the functionality of editing systems may be improved by allowing developers to more naturally interact with the editing systems, as well as significantly decreasing the amount of time typically associated with rendering and updating virtual environments. Additionally, by allowing developers and other users to render, update, and otherwise interact with virtual environments and simulation systems using natural language inputs, users may no longer need the type or degree of specialized knowledge typically required for designing and modifying virtual environments.

### BRIEF DESCRIPTION OF THE DRAWINGS

The present systems and methods for a language model-based interface for simulation systems and applications are described in detail below with reference to the attached drawing figures, wherein:

FIG. 1 is a data flow diagram illustrating an example of a process for using a language model-based interface for generating a simulation environment, in accordance with some embodiments of the present disclosure;

FIGS. 2A-2C illustrate a visualization of a series of inputs applied to a language model to generate a virtual environment, in accordance with some embodiments of the present disclosure;

FIG. 3 is a data flow diagram illustrating an example of a process for training a machine learning model, in accordance with some embodiments of the present disclosure;

FIG. 4 is a flow diagram illustrating an example of a method for using a language model to render objects in a virtual environment, in accordance with some embodiments of the present disclosure;

FIG. 5 is a flow diagram illustrating an example of a method for using a language model to generate a virtual environment, in accordance with some embodiments of the present disclosure;

FIG. 6 is a flow diagram illustrating an example of a method for using a language model to generate ground truth data from a simulation, in accordance with some embodiments of the present disclosure;

FIG. 7A is a block diagram of an example generative language model system suitable for use in implementing at least some embodiments of the present disclosure;

FIG. 7B is a block diagram of an example generative language model that includes a transformer encoder-decoder suitable for use in implementing at least some embodiments of the present disclosure;

FIG. 7C is a block diagram of an example generative language model that includes a decoder-only transformer architecture suitable for use in implementing at least some embodiments of the present disclosure;

FIGS. 8A-8F are example illustrations of a simulation system, in accordance with some embodiments of the present disclosure;

FIG. 9A is an example illustration of a simulation system at runtime, in accordance with some embodiments of the present disclosure;

FIG. 9B includes a cloud-based architecture for a simulation system, in accordance with some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing at least some embodiments of the present disclosure; and

FIG. 12 is a block diagram of an example data center suitable for use in implementing at least some embodiments of the present disclosure.

### DETAILED DESCRIPTION

Systems and methods are disclosed related to a language model-based interface for simulation systems and applications. For instance, user inputs (e.g., speech inputs, text inputs, etc.) may be applied to a language model (e.g., large language model, vision language model, etc.) that is trained to interact with a simulation system and/or control various aspects of a simulation. In some examples, the language model may generate code for, among other things, creating and/or customizing a virtual environment associated with the simulation. For instance, the generated code may include, but is not limited to, code for rendering one or more portions of the virtual environment, code for rendering and simulating behaviors of virtual agents (e.g., pedestrians, vehicles, animals, etc.) and/or any other objects (e.g., road signs, buildings, trees, etc.) within the virtual environment, code for recreating and simulating real-world events from recorded sensor data, and/or any other type of code associated with generating and/or updating the simulation In some examples, the language model may be trained to make specific API calls and/or cause the code to be executed by the simulation system.

For instance, a system(s) may obtain input data representative of a user request(s). In some examples, the user request(s) may include a request associated with creating a virtual environment. For instance, the request may include one or more parameters associated with a virtual environment requested to be rendered (e.g., “generate a scene including a road with two lanes,” “generate a scene using the image data captured during yesterday's drive,” etc.). Additionally, or alternatively, the request may include parameters for rendering objects or virtual agents (e.g., pedestrians, vehicles, etc.) in the virtual environment (e.g., “spawn vehicles on the road,” “spawn ten pedestrians in the environment,” “place trees next to the sidewalks,” etc.). In some examples, the request may include parameters for simulating behaviors of objects or virtual agents in the virtual environment (e.g., “make the pedestrian wave,” “make the vehicle turn right,” etc.). As another example, the request may include parameters for changing features of the environment (e.g., “make the weather rainy,” “make the weather snowy,” etc.). While these are just a few examples, in additional or alternative embodiments, and as described in more detail herein, the user requests may include any kind of requests associated with a simulation, such as requests to generate ground truth data, requests to highlight or identify certain objects in the environment, requests for sensor data returns or perception outputs of a simulated machine in the simulation, or any other requests.

In some examples, the user request(s) may be received in a variety of data formats and/or using a variety of modalities. For instance, the user request(s) may be received as text data (e.g., based on a user typing in the request(s)), as audio data (e.g., based on a user utterance/speech), as image data (e.g., based on user sign language, handwriting, etc.), and/or as any other type of data. In some examples, such as in the case of audio data representing user speech, the audio data may be preprocessed to convert the audio data into text data. For instance, the audio data may be preprocessed using one or more automatic speech recognition (ASR) models, one or more natural language understanding (NLU) models, one or more speech processing pipelines, and/or any other type of speech processing components to convert the audio data into text. Similarly, in the context of image data, the image data may be preprocessed using computer vision techniques, vision language models, or any other techniques to convert sign language signals into text. Additionally, in some examples, multimodal language models (MMLMs) may be used to process these different modalities of inputs/user requests.

In some examples, the input data (e.g., preprocessed input data) may be applied to one or more language models (e.g., large language models) that are trained to interact with a simulation system. For instance, the language model(s) may be trained or shown documentation/examples (e.g., examples of code, API calls, etc.) to perform various operations to control, modify, or otherwise interact with the simulation system. In some examples, this may include the language model(s) performing various operations that users or developers may manually perform with respect to the simulation system, such as creating or updating an appearance of a virtual environment associated with a simulation, changing behaviors of virtual agents within the simulation, obtaining results from running simulations, evaluating and/or computing metrics associated with the simulations, or any other operations. By way of example, and not limitation, the system(s) of the present disclosure may be used to more easily create rare and/or extreme scenarios in simulations, review and/or curate sensor datasets, scale simulation scenarios to different variants, as well as to obtain synchronized sensor data and ground truth data from these simulations (e.g., occupancy voxels, detected objects, object classifications, etc.), which may be used for training and/or validation.

In some examples, the language model(s) may allow for users and developers to interact with point clouds to perform various operations, such as identifying specific objects in the simulation environment (e.g., cars, constructions vehicles, traffic lights, etc.). In some examples, the language model(s) may be configured such that users may build drivable maps from text or speech inputs, as well as turning such maps into full simulations to easily scale out new training scenarios. Additionally, with simple text and/or voice prompts, developers may also change simulation environment conditions (e.g., weather, etc.). For instance, a generative pretrained transformer may be provided a retrieval augmented generation (RAG) document that includes information on how to generate code (e.g., TOML code, Python code, etc.) to change weather, spawn different objects, or otherwise control the simulation system. In at least one example, users may enter text from crash reports and the language model(s) may generate code and perform other operations to recreate a full simulation of the events based on the crash reports. Once such scenarios are built, developers may then use this data and/or query the system(s) (e.g., via the language model(s)) to produce useful ground truth data, such as occupancy voxels, road elements for simulated sensors, etc.

In some examples, the system(s) may further use Neural Radiance Fields (NeRFs) or other volumetric representations (e.g., multi-dimensional Gaussian splats) to create simulations from on-road image data captured using sensors (e.g., cameras) of a machine operating in a real environment, thereby allowing developers to rapidly recreate simulation events from real world events for training and/or testing. For instance, NeRFs may be reconstructed from real drives of real vehicles or a Gaussian splat may be constructed from a point cloud representation of objects from one or more drives, and used to create new driving scenarios for the simulation system. In some instances, synthetic objects (e.g., objects that were not present in the real environment and/or the image data) may be added to the volumetric-based simulations, such as pedestrians, vehicles, cyclists, barriers, etc. using the language model interface(s) of the present disclosure. Additionally, in some instances, a LiDAR data may be added to the simulation to get LiDAR return points/labels/materials, which may then be converted to occupancy voxels. Further, in some examples, the system(s) may create driving video segments of a single camera or multiple synchronized camera views on the vehicle, allowing for quick scaling of validation and testing.

As described herein, in some examples, based at least on applying the input data to the language model(s), the language model(s) may generate one or more input tokens corresponding to one or more words, sub-words, or characters included in the input data. For example, if the input data includes a text string that says “spawn a pedestrian on the sidewalk,” the language model(s) may tokenize the input data into the following tokens: [“spawn”, “a”, “pedestrian”, “on”, “the”, “side”, “walk”]. In some instances, the language model(s) may then convert the input tokens into numerical representations (also referred to as “embeddings”) that capture their semantic meaning and may be used as input for other models of the language model(s) architecture. For instance, each token may be mapped to a vector in a high-dimensional space, reflecting that token's (or that word's or sub-word's) context and/or meaning.

In some examples, the language model(s) may process the input tokens and/or embeddings using a neural network and/or other machine learning algorithm/model. The language model(s) may include the neural network and/or other models as part of its architecture. In some instances, the language model(s) may use its neural network to understand the context and intent of the input prompt. For instance, the language model(s) may use the neural network to process the input tokens to grasp a requirement(s) of the task, which, in accordance with the above example, is to render a pedestrian on a sidewalk in the simulation environment. The language model(s) may further understand that to render the pedestrian on the sidewalk, the language model(s) may need to generate code for accomplishing the task, call one or more APIs, cause the generated code to be executed, etc. In some examples, the language model(s) may include or use one or more attention mechanisms to help the language model(s) focus on relevant parts of the input data and maintain context. The attention mechanism(s) may help the language model(s) to weigh the importance of different tokens relative to each other. In some instances, the language model(s) may also encode the input tokens considering their relationships and context, producing a representation that reflects the entire input sequence. For instance, the language model(s) may generate context-aware embeddings that understand the specifics of the input task.

In some examples, based on processing the input tokens/embeddings to understand the context and intent of the input, as well as the requirements of the task, the language model(s) may generate one or more output tokens. In some examples, the output token(s) may be representative of one or more portions of code. For instance, continuing the example from above in which the input data is a text string asking to “spawn a pedestrian on the sidewalk,” the output token(s) may represent one or more portions of code that may be used for rendering the pedestrian on a sidewalk in the virtual environment. Additionally, in some examples, the output token(s) may be representative of one or more instructions for calling one or more APIs, such as an API for rendering pedestrians and/or other virtual agents in the simulation environment.

In some instances, the language model(s) (and/or another model or other type of processing component) may perform one or more post-processing operations on the output token(s). For instance, the language model(s) may detokenize the output tokens or otherwise convert the output tokens back into human-readable text (or machine-readable code, in some instances). That is, the language model(s) may generate text representing the code based on detokenizing the output tokens. In some examples, the language model(s) may format and/or structure the text so that the text (e.g., code) may be syntactically correct and adhere to coding conventions. For instance, the language model(s) may format the output text based on syntax rules corresponding to a programming language that is used by the simulation platform. In at least one example, the language model(s) may format the text according to TOML syntax rules and/or Python syntax rules, however other syntax rules for other programming languages may also be used depending on requirements.

In some examples, the language model(s) may supplement incomplete or less detailed queries with various information to generate outputs. For example, assume that to spawn a pedestrian, a number of attributes for the pedestrian need to be defined in code, such as the pedestrian's starting location, ending location, route/waypoints, age, gender, attire (e.g., business, construction worker, police officer, etc.), or any other attributes. As such, if an input includes a request to “spawn a pedestrian on a sidewalk,” the language model(s) may fill in some of the non-specified attributes of the pedestrian in code, as well as determine certain attributes from the input. For instance, to spawn a pedestrian on the sidewalk, the language model(s) may determine starting location coordinates along the sidewalk for spawning the pedestrian at. In other words, instead of just spawning the pedestrian at any coordinate location in the environment, the language model(s) may determine a subset of starting coordinates that would allow for spawning the pedestrian on the sidewalk. Additionally, since the input request did not specify the pedestrians age, gender, route, etc., the language model(s) may randomize these attributes and/or use context to make a best estimate as to these attributes (e.g., route of the pedestrian includes a route along the sidewalk).

In some embodiments, the system(s) of the present disclosure may be used in addition to, or alternatively from, a simulation to generate synthetic training data for training other systems, models, or applications. For example, the synthetic training data may be generated using neural rendering fields (NERFs), Gaussian splat techniques, diffusion models, electrostatic models (e.g., Poisson flow generative models (PFGMs), etc. The language model interface(s) of the present disclosure may be used to modify the synthetic training data (e.g., spawn traffic, pedestrians, or other objects etc.). The synthetic training data (in addition to or alternatively from real-world data) may then be processed to determine geometry, curvature, semantic information, classification information, and/or other information related to features of interest (e.g., features specified in the language model inputs), such as lines, longitudinal features (e.g., poles), and/or other features within a driving environment, a warehouse, etc., for example.

In some examples, the system(s) may use the output text from the language model(s) to update or otherwise control the simulation platform. For instance, following the example from above in which the text represents code for rendering a pedestrian in the simulation environment, the system(s) may use the text to cause a rendering of the pedestrian on the sidewalk in the simulation/virtual environment. In some instances, the system(s) may make one or more API calls to one or more APIs associated with the simulation system, and the text representing the code may be used in the API calls(s) to cause the rendering of the pedestrian. For instance, various different APIs may be designed and/or used for various tasks, and the language model(s) may be trained to correctly call and use certain APIs for certain tasks. As one example, an API may be created for spawning pedestrians, vehicles, or other synthetic agents, and the language model(s) may be trained to make API calls to these APIs when necessary.

In any example, the simulation environment and/or virtual environment may be rendered or otherwise generated using one or more light transport algorithms—such as ray-tracing and/or path-tracing algorithms. In some embodiments, the simulation/virtual environment and/or one or more objects, features, or components thereof may be generated or managed within a three-dimensional (3D) content collaboration platform (e.g., NVIDIA's OMNIVERSE) for industrial digitalization, generative physical AI, and/or other use cases, applications, or services. For example, the content collaboration platform or system may include a system that uses universal scene descriptor (USD) (e.g., OpenUSD) data for managing objects, features, scenes, etc. within a simulated environment, digital environment, etc. The platform may include real physics simulation, such as using NVIDIA's PhysX SDK, in order to simulate real physics and physical interactions with simulations hosted by the platform. The platform may integrate OpenUSD along with ray tracing/path tracing/light transport simulation (e.g., NVIDIA's RTX rendering technologies) into software tools and simulation workflows for building, training, deploying, or testing AI systems—such as systems for testing, validating, training (e.g., machine learning models, neural networks, etc.), and/or other tasks related to automotive, robot, machine, or other applications. The system(s) of the present disclosure may enable developers/users to interact with these systems (e.g., the 3D content collaboration platform, etc.) more naturally using language models and natural language inputs.

In some examples, to enable the language model(s) to interact with the simulation system, documentation including one or more examples of sample code, API calls, etc. for controlling aspects of the simulation may be shown or otherwise applied to the language model(s). That is, while in some instances it may be advantageous to specifically train the language model(s) to generate code, API calls, etc. for controlling the simulation systems, in some scenarios it may be more advantageous and efficient to show the language model(s) this documentation to “teach” the model(s) how to generate the code, API calls, etc. in real time. In this way, as the simulation systems, code syntax, API call syntax, etc. is updated, it may not be necessary to retrain the model(s). In at least one example, the documentation may include examples of code to cause the simulation system to render a simulation environment, spawn and control virtual agents such as pedestrians or vehicles in the simulation environment, change the weather in the simulation environment, modify the appearance or locations of objects within the simulation environment, output occupancy voxels associated with objects in the simulation environment, or cause the simulation environment to perform any other operations. To train a specialized version of the language model(s) to generate code, API calls, etc. to interact with the simulation system, the system(s) may cause the language model(s) to process one or more training datasets to learn to tokenize the code examples, and the tokens may represent keywords, symbols, or even entire lines of code. The language model(s) may then be trained on the tokenized data using supervised learning techniques, and the language model(s) may learn to predict the next token in a sequence, given the previous tokens. In various examples, one or more parameters of the language model(s) may be refined over the course of training until the model(s) generate acceptable outputs. For instance, in the context of code generation, the parameters of the model(s) may be refined or updated until the output code is in the correct syntax and includes complete instructions for accomplishing specific tasks for the simulation.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such as an inference microservice (e.g., NVIDIA NIMs)—which may include a container (e.g., an operating system (OS)-level virtualization package) that may include an application programming interface (API) layer, a server layer, a runtime layer, and/or a model “engine.” Additionally, or alternatively, the system(s) of the present disclosure may make one or more calls or requests to such inference microservices. In some examples, these inference microservices may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

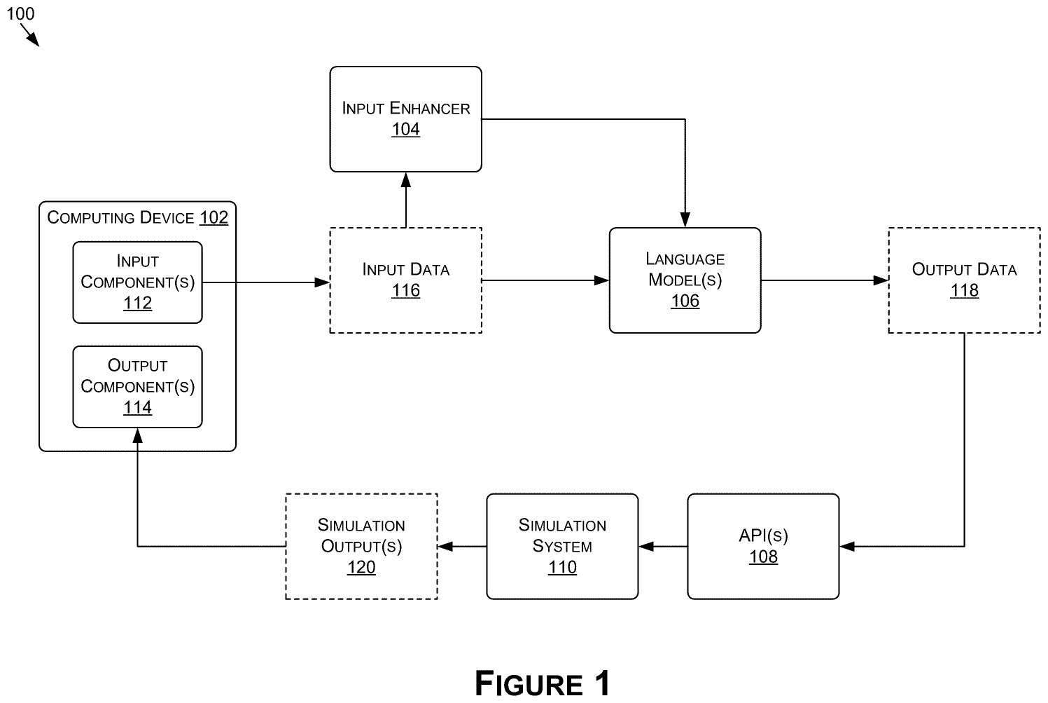

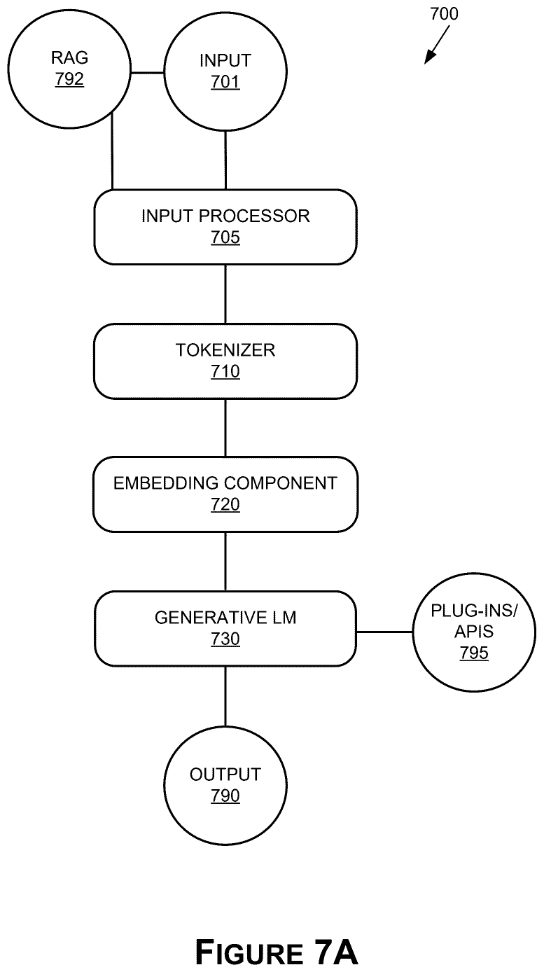

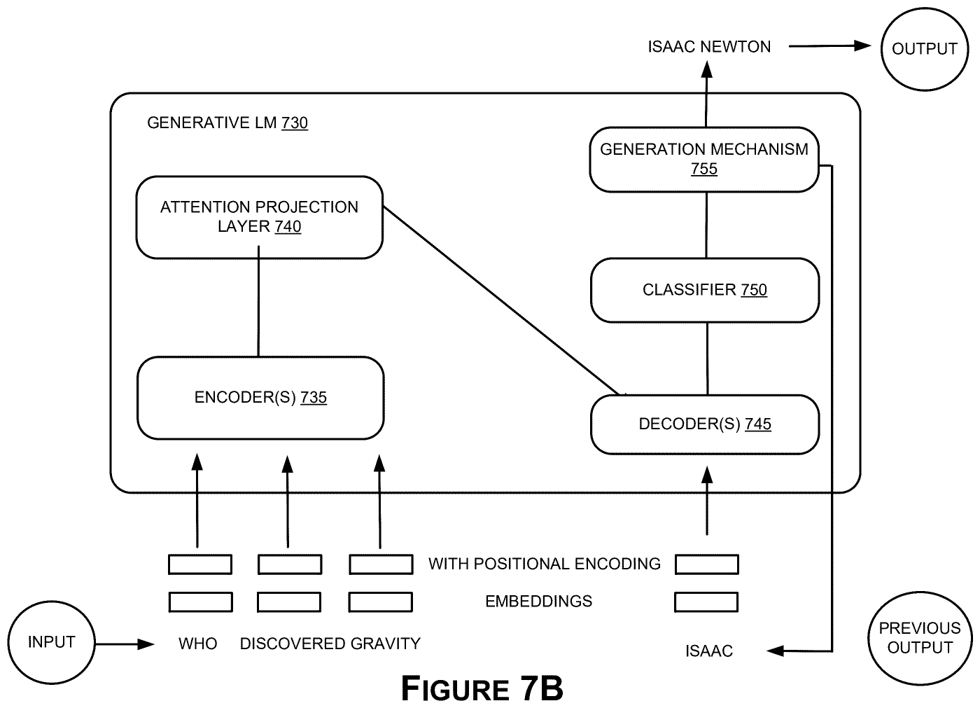

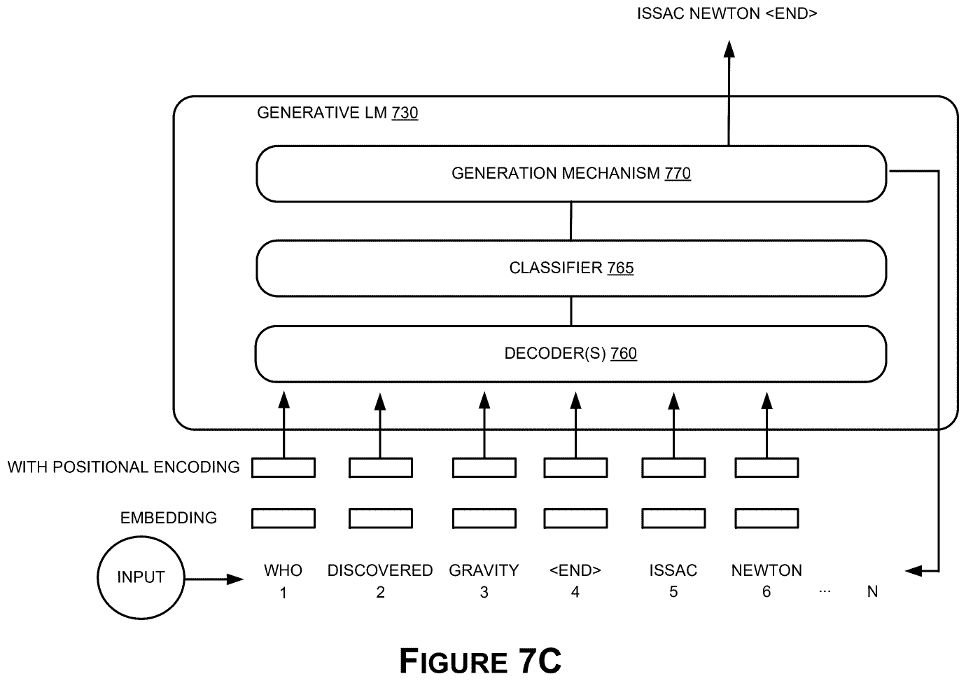

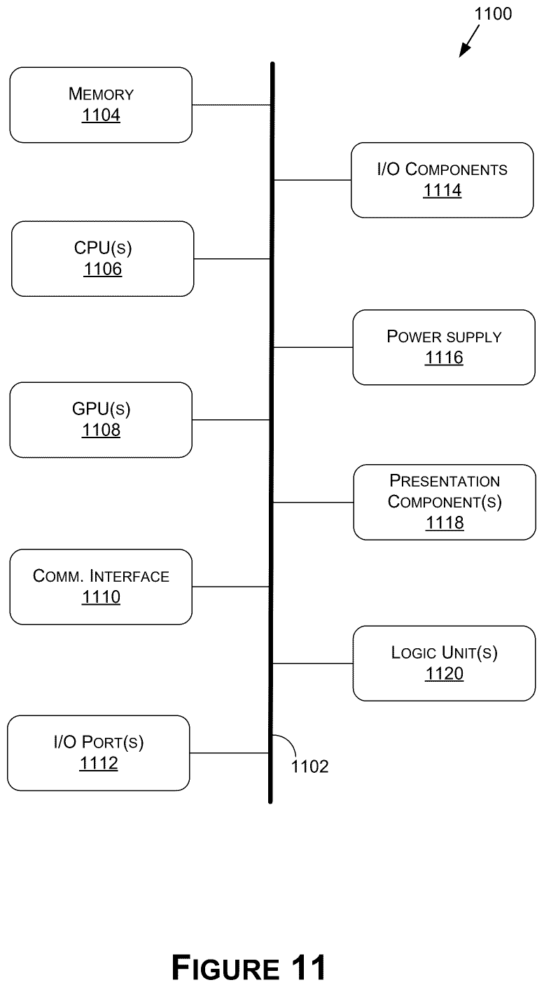

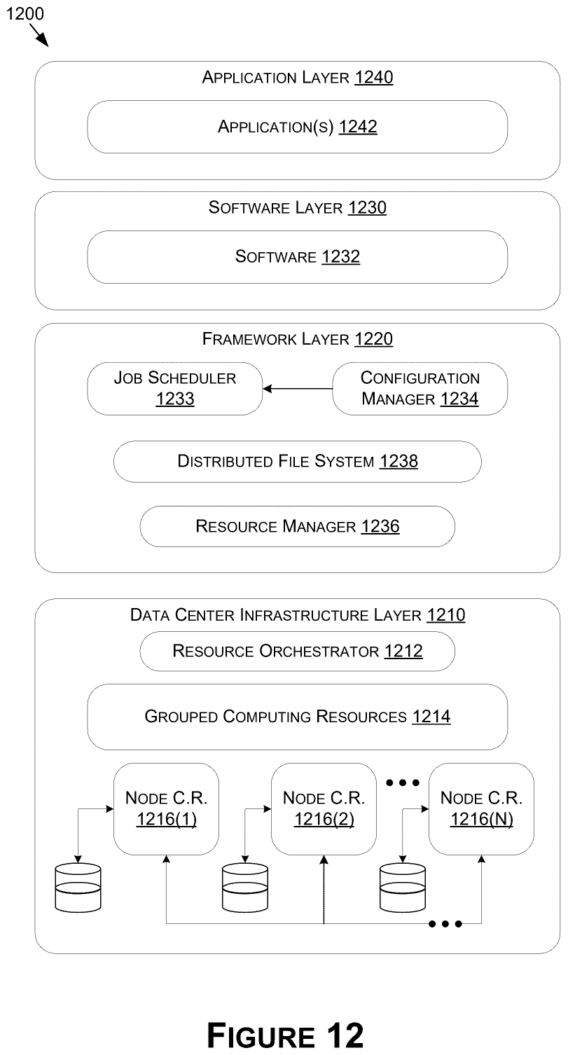

With reference to FIG. 1, FIG. 1 is a data flow diagram illustrating an example of a process 100 for using a language model-based interface for generating a simulation environment, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 7A-7C), one or more computing devices or components thereof (e.g., as described in FIG. 11), and/or one or more data centers or components thereof (e.g., as described in FIG. 12).

The process 100 may be implemented using, amongst additional or alternative components, a computing device 102, an input enhancer 104, one or more language models 106, one or more application programming interfaces (API(s)) 108, and a simulation system 110. The computing device 102 may, in some examples, include one or more input components 112 and/or one or more output components 114. As a brief overview of the process 100, the language model(s) 106 may receive input data 116 from the input component(s) 112 of the computing device 102. In some examples, the input enhancer 104 may be used to retrieve additional information to be used as part of the input to the language model(s) 106. The language model(s) 106 may process the input data 116 and/or additional information from the input enhancer 104 and generate output data 118. As described herein, the output data 118 may include code, API calls, or any other data for controlling the simulation system 110. The output data 118 may be sent to the API(s) 108, which may use at least a portion of the output data 118 to control the simulation system 110. For instance, the API(s) 108 may include an API for rendering or spawning virtual agents in the simulation environment, and the API may use the code in the output data 118 to render or spawn the virtual agents. The simulation system 110 may generate one or more simulation outputs 120 (e.g., image/video frames, audio, etc.) and the simulation output(s) 120 may be sent to the output component(s) 114 of the computing device 102. For instance, the output component(s) 114 may include a display, and the frames of the simulation may be presented on the display.

In some examples, the input data 116 may be representative of a user request(s). In some examples, the user request(s) may include a request associated with creating a virtual environment for a simulation. For instance, the request may include one or more parameters associated with a virtual environment requested to be rendered (e.g., “generate a scene including a road with two lanes”). Additionally, or alternatively, the request may include parameters for rendering objects or virtual agents (e.g., pedestrians, vehicles, etc.) in the virtual environment (e.g., “spawn vehicles on the road,” “add sidewalks on each edge of the road,” “place trees next to the sidewalks,” etc.). In some examples, the request may include parameters for simulating behaviors of objects or virtual agents in the virtual environment (e.g., “make the pedestrian wave,” “make the vehicle turn right,” etc.). As another example, the request may include parameters for changing features of the environment (e.g., “make the weather rainy,” “make the weather snowy,” etc.). While these are just a few examples, in additional or alternative embodiments, the input data 116 may include any kind of requests associated with a simulation or the simulation system 110, such as requests to generate ground truth data, requests to highlight or identify certain objects in the environment, requests for sensor data returns or perception outputs of a simulated machine in the simulation, or any other requests.

In some examples, the input data 116 may be received in a variety of data formats and/or using a variety of different input components 112. For instance, the input data 116 may be received as text data (e.g., based on a user typing in the request(s)), as audio data (e.g., based on a user utterance/speech), as image data (e.g., based on user sign language, handwriting, etc.), and/or as any other type of data. In some examples, such as in the case of audio data representing user speech, the input data 116 may be preprocessed to convert the audio data into text data. For instance, audio data may be preprocessed using one or more automatic speech recognition (ASR) models and/or pipelines. Similarly, in the context of image data, the image data may be preprocessed using computer vision techniques, vision language models, or any other techniques to convert sign language signals into text inputs.

In some examples, the input enhancer 104 (which may correspond to the RAG component 792 described herein) may use the input data 116 and/or a preprocessed version of the input data 116 to retrieve additional information to be used as part of the input or prompt to the language model(s) 106. For instance, the input enhancer 104 may use retrieval augmented generation (RAG) to enhance the input data 116 applied to the language model(s) 106—and/or any other models herein—with external knowledge, so that outputs generated in response to specific questions or queries or requests are more relevant, such as in a case where specific knowledge is required. This additional information may then be fed to the language model(s) 106 along with the input data 116 to improve accuracy of the responses or outputs of the language model(s) 106. In some examples, the additional information may include documents of code examples and/or API calls for interacting with the simulation system (e.g., spawning virtual agents, adding or removing objects or other features, controlling behavior of virtual agents, changing weather, changing colors or appearances of environment features, obtaining ground truth frames, etc.).

For example, in some embodiments, an input (e.g., text string) may be generated using the input data 116 in addition to data retrieved using the input enhancer 104. In some embodiments, an input processor (not shown) may analyze the input data 116 and communicate with the input enhancer 104 in order to identify relevant text and/or other data to provide to the language model(s) 106 as additional context or sources of information from which to identify the response, answer, or output data 118, generally. For example, where the input indicates that the user is interested in spawning a pedestrian in the simulation environment, the input enhancer 104 may retrieve examples of code corresponding to pedestrians in the simulation environment.

In some examples, the input enhancer 104 may supplement incomplete or less detailed queries with various information to generate outputs. For example, assume that to spawn a pedestrian, a number of attributes for the pedestrian need to be defined in code, such as the pedestrian's starting location, ending location, route/waypoints, age, gender, attire (e.g., business, construction worker, police officer, etc.), or any other attributes. As such, if the input data 116 includes a request to “spawn a pedestrian on a sidewalk,” the input enhancer 104 may fill in some of the unspecified attributes of the pedestrian. For instance, the input enhancer 104, in some examples, may modify the request from “spawn a pedestrian on a sidewalk” to “spawn an adult female pedestrian wearing business attire at (x, y) coordinate location and walking a route that includes the following waypoints (x1, y1), (x2, y2), and (x3, y3).” In other words, since the input request did not specify the pedestrians age, gender, route, etc., the input enhancer 104 may randomize these attributes and/or use context to make a best estimate as to these attributes (e.g., route of the pedestrian includes a route along the sidewalk).

In some examples, the input data 116 (e.g., preprocessed input data) may be applied to the language model(s) 106, which may be trained to interact with the simulation system 110 based on the input data 116. For instance, the language model(s) 106 may be trained to perform various operations to control, modify, or otherwise interact with the simulation system 110. In some examples, this may include the language model(s) 106 performing various operations that users or developers may manually perform with respect to the simulation system 110, such as creating or updating an appearance of a virtual environment associated with a simulation, changing behaviors of virtual agents within the simulation, obtaining results from running simulations, evaluating and/or computing metrics associated with the simulations, or any other operations. By way of example, and not limitation, the language model(s) 106 may be used to more easily create rare and/or extreme scenarios in simulations, review and/or curate sensor datasets, scale simulation scenarios to different variants, as well as to obtain synchronized sensor data and ground truth data from these simulations (e.g., occupancy voxels, detected objects, object classifications, etc.), which may be used for training and/or validation.

In some examples, the language model(s) 106 may allow for users and developers to interact with point clouds to perform various operations, such as identifying specific objects in the simulation environment (e.g., cars, constructions vehicles, traffic lights, etc.). In some examples, the language model(s) 106 may be configured such that users may build drivable maps from text or speech inputs, as well as turning such maps into full simulations to easily scale out new training scenarios. Additionally, with simple text and/or voice prompts, developers may also change simulation environment conditions (e.g., weather, traffic, etc.). In at least one example, the input data 116 may include text from crash reports and the language model(s) 106 may generate code and/or perform other operations to recreate a full simulation of the events based on the crash reports. Once such scenarios are built, developers may then use this data and/or query the simulation system 110 (e.g., via the language model(s) 106) to produce useful ground truth data, such as occupancy voxels, road elements for simulated sensors, etc.

As described herein, in some examples, based at least on applying the input data 116 to the language model(s) 106, the language model(s) 106 may generate one or more input tokens corresponding to one or more words, sub-words, or characters included in the input data 116. For instance, if the input data 116 includes a text string that says “spawn a pedestrian on the sidewalk,” the language model(s) 106 may tokenize the input data 116 into the following tokens: [“spawn”, “a”, “pedestrian”, “on”, “the”, “side”, “walk”]. In some instances, the language model(s) 106 may then convert the input tokens into numerical representations (also referred to as “embeddings”) that capture their semantic meaning and may be used as input for other models of the language model(s) 106 architecture. For instance, each token may be mapped to a vector in a high-dimensional space, reflecting the context or meaning of that token (or word or sub-word).

In some examples, the language model(s) 106 may process the input tokens and/or embeddings using a neural network and/or other machine learning algorithm/model. The language model(s) 106 may include the neural network and/or other models as part of its architecture. In some instances, the language model(s) 106 may use its neural network to understand the context and intent of the input prompt. For instance, the language model(s) 106 may use the neural network to process the input tokens to determine a requirement(s) of the task, which, in accordance with the above example, is to render a pedestrian on a sidewalk in the simulation environment. The language model(s) 106 may further understand that to render the pedestrian on the sidewalk, the language model(s) 106 may need to generate code for accomplishing the task, call one or more APIs, cause the generated code to be executed, etc. In some examples, the language model(s) 106 may include or use one or more attention mechanisms to help the language model(s) 106 focus on relevant parts of the input data 116 and maintain context. The attention mechanism(s) may help the language model(s) 106 to weigh the importance of different tokens relative to each other. In some instances, the language model(s) 106 may also encode the input tokens considering their relationships and context, producing a representation that reflects the entire input sequence. For instance, the language model(s) 106 may generate context-aware embeddings that understand the specifics of the input task.

Although examples are described herein with respect to using neural networks within the language models and/or other machine learning models described herein, this is not intended to be limiting. For example, and without limitation, any of the various machine learning models described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In some examples, based on processing the input tokens/embeddings to understand the context and intent of the input data 116, as well as the requirements of the task, the language model(s) 106 may generate one or more output tokens. In some examples, the output token(s) may be representative of one or more portions of code. For instance, continuing the example from above in which the input data 116 is a text string asking to “spawn a pedestrian on the sidewalk,” the output token(s) may represent one or more portions of code that may be used for rendering the pedestrian on a sidewalk in the virtual environment. Additionally, in some examples, the output token(s) may include one or more tokens (e.g., words, functions, etc.) for calling one or more APIs, such as an API for rendering pedestrians and/or other virtual agents in the simulation environment.

In some instances, the language model(s) 106 may perform one or more post-processing operations on the output token(s). For instance, the language model(s) 106 may detokenize the output tokens or otherwise convert the output tokens back into human-readable text (or machine-readable code, in some instances). That is, the language model(s) 106 may generate text representing the code based on detokenizing the output tokens. In some examples, the language model(s) 106 may format and/or structure the text so that the text (e.g., code) may be syntactically correct and adhere to coding conventions. For instance, the language model(s) 106 may format the output text based on syntax rules corresponding to a programming language that is used by the simulation platform. In at least one example, the language model(s) 106 may format the text according to TOML syntax rules and/or Python syntax rules, however other syntax rules for other programming languages may also be used depending on requirements.

In some examples, the language model(s) 106 may generate the output data 118. The output data 118 may include text output from the language model(s) 106. In some examples, the text may represent or correspond to code for updating or otherwise controlling various aspects of the simulation system 110. For instance, following the example from above in which the output text represents code for rendering a pedestrian in the simulation environment, the API(s) 108 may use the text to cause a rendering of the pedestrian on the sidewalk in the simulation/virtual environment. In some instances, the output data 118 may include text representing code for making one or more API calls to the API(s) 108 associated with the simulation system 110. For instance, various different API(s) 108 may be designed and/or used for various tasks, and the language model(s) 106 may be trained to correctly call and use certain API(s) 108 for certain tasks associated with the simulation system 110. As an example, a first API may be used for rendering virtual agents, a second API may be used for customizing the virtual environment (e.g., adding features and/or objects to the environment), a third API may be used for querying the simulation system 110, a fourth API may be used for obtaining ground truth data from the simulation system 110, and so forth.

In some examples, the simulation system 110 may use Neural Radiance Fields (NeRFs) to create simulations from on-road image data captured using sensors (e.g., cameras) of a machine operating in a real environment, thereby allowing developers to rapidly recreate simulation events from real world events for training and/or testing. For instance, NeRFs may be reconstructed from real drives of real vehicles, and used to create new driving scenarios for the simulation system 110. In some instances, synthetic objects (e.g., objects that were not present in the real environment and/or the image data) may be added to the NeRF-based simulations, such as pedestrians, vehicles, cyclists, barriers, etc. For example, the input data 116 may include a natural language request to generate a simulation using image data generated using a camera of a vehicle. The input data 116 may include a file name, storage location, and/or reference ID associated with the image data. In such an example, the output data 118 may include, among other things, an API call to the API(s) 108 to generate a NeRF representation of the environment depicted in the image data. Additionally, or alternatively, the input data 116 may include a request to spawn one or more synthetic objects (e.g., objects or agents that were not in the recording) in the NeRF simulation, and the language model(s) 106 may generate code or take the necessary steps to spawn the synthetic object(s).

In various examples, the simulation system 110 may generate the simulation output(s) 120. The simulation output(s) 120 may include, but is not limited to, image frames of the simulation, audio data associated with the simulation, image frames depicting labeled, ground truth features in the simulation environment (e.g., labeled objects, labeled lane lines, etc.), image frames depicting occupancy voxels in the simulation environment (e.g., locations of 3D voxels that are occupied by objects), etc. In any example, these simulation output(s) 120 may be sent to the computing device 102 for output using the output component(s) 114. The output component(s) 114 may include, but is not limited to, a display (e.g., LCD screen, monitor, projector, or any other visual display device), an audio output system (e.g., speakers, etc.), or any other output device or devices. In some examples, the output component(s) 114 may be displaying a user interface associated with the simulation system 110, and the user interface may be configured to receive the input data 116 and display the simulation output(s) 120. In other words, the computing device 102 may use the output component(s) 114 to display a user interface or frontend system associated with the simulation system 110, while the input enhancer 104, language model(s) 106, API(s) 108, and/or simulation system 110 may reside on one or more backend systems (e.g., servers) remote from the computing device 102.

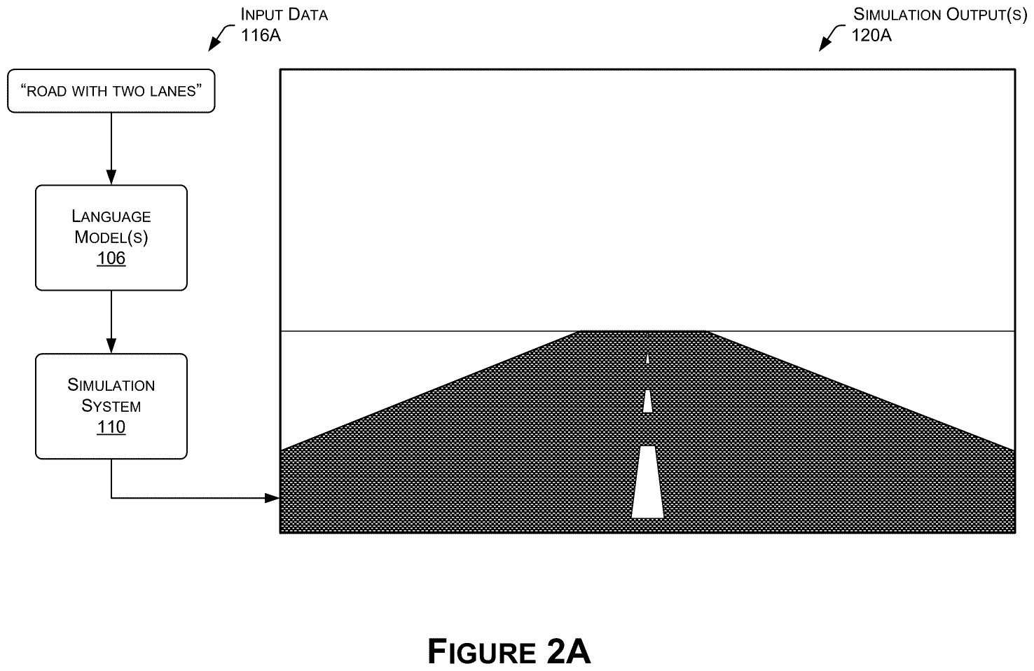

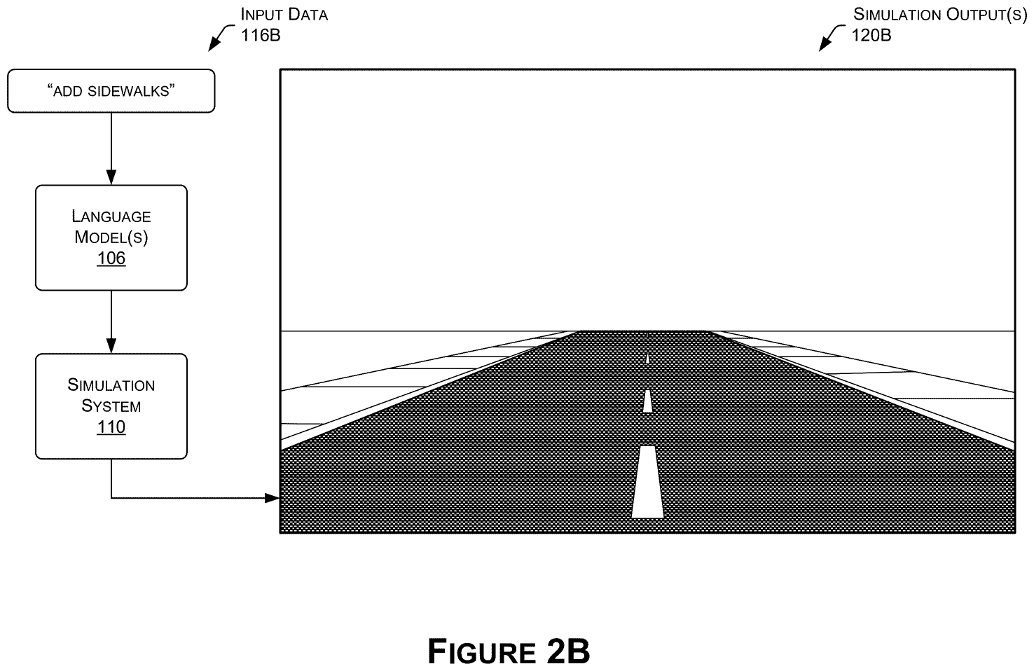

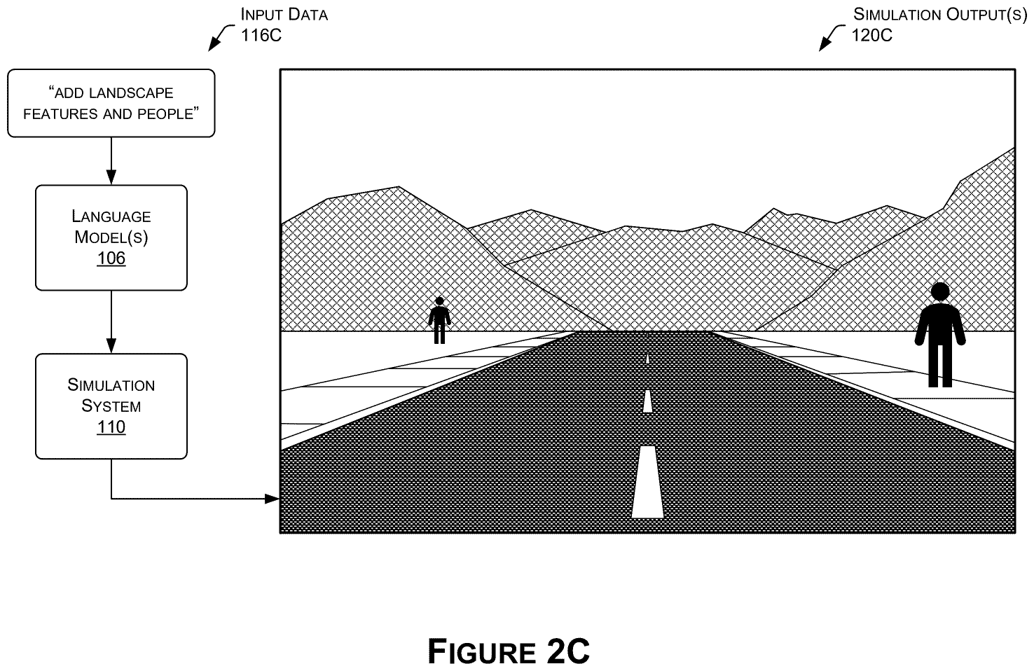

Referring now to FIGS. 2A-2C, FIGS. 2A-2C illustrate a visualization of a series of inputs applied to a language model to generate a virtual environment, in accordance with some embodiments of the present disclosure. Referring first to FIG. 2A, input data 116A is applied to the language model(s) 106 at a first time. The input data 116A includes a string of text that says “road with two lanes.” The language model(s) 106 may process the input data 116A and generate code, API calls, etc. to cause the simulation system 110 to render a road with two lanes in the simulation environment. For instance, the outputs of the language model(s) 106 may be fed into the simulation system 110, and the simulation system 110 may generate the simulation output(s) 120A. In accordance with the request in the input data 116A, the simulation output(s) 120A may include one or more frames depicting an environment that includes a road with two lanes, as shown in the example of FIG. 2A.

Referring now to FIG. 2B, input data 116B is applied to the language model(s) 106 at a second time after the first time. The input data 116B includes a string of text that says “add sidewalks.” The language model(s) 106 may process the input data 116B and generate code, API calls, etc. to cause the simulation system 110 to update the virtual environment to include sidewalks along the road. For instance, the outputs of the language model(s) 106 may be fed into the simulation system 110, and the simulation system 110 may generate the simulation output(s) 120B. In accordance with the request in the input data 116B, the simulation output(s) 120B may include one or more frames depicting an environment that includes a road with two lanes and sidewalks along the road, as shown in the example of FIG. 2B.

Referring now to FIG. 2C, input data 116C is applied to the language model(s) 106 at a third time after the second time. The input data 116C includes a string of text that says, “add landscape features and people.” The language model(s) 106 may process the input data 116C and generate code, API calls, etc. to cause the simulation system 110 to update the virtual environment to include the landscape features (e.g., mountains) and the pedestrians. For instance, the outputs of the language model(s) 106 may be fed into the simulation system 110, and the simulation system 110 may generate the simulation output(s) 120C. In accordance with the request in the input data 116C, the simulation output(s) 120C may include one or more frames depicting an environment that includes a road with two lanes, sidewalks along the road, landscape features, and pedestrians, as shown in the example of FIG. 2B.

While these are just a couple of examples, in additional or alternative examples, other inputs and requests may be applied to the language model(s) to control aspects of the simulation. For instance, input requests to spawn vehicles, animals, other objects, etc. may be received and the simulation system may update the simulation environment accordingly. Additionally, or alternatively, input requests to control behaviors of the pedestrians and/or virtual agents, change environmental conditions (e.g., weather) of the simulation, etc. may be received and the simulation system may update the simulation. In any example, users and developers may query the simulation system, via the language model(s), to perform any number of operations that the simulation system is capable of performing.

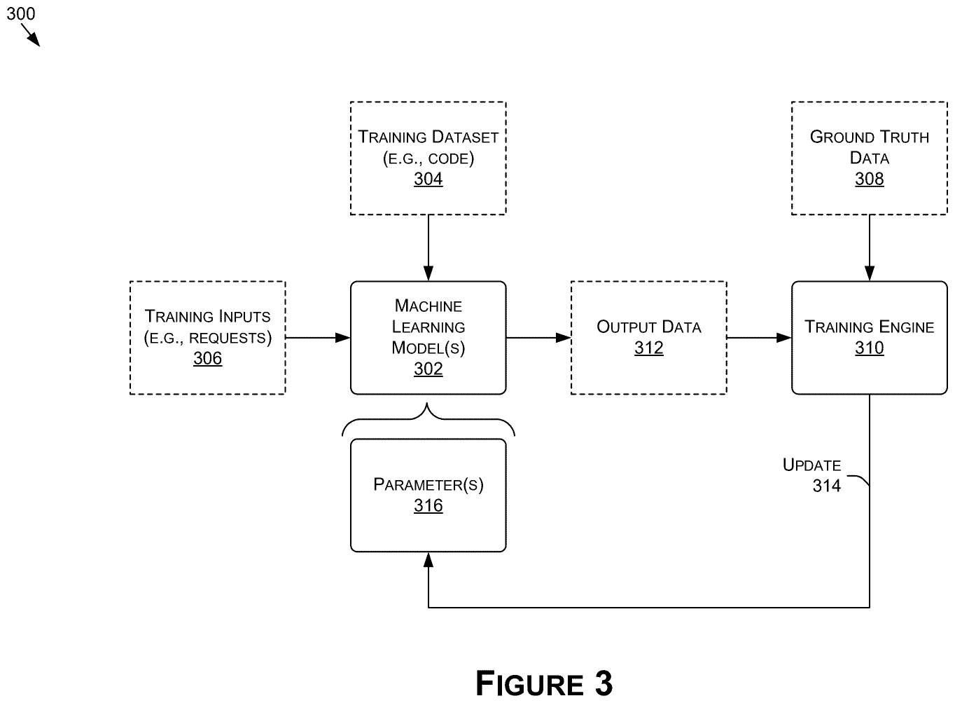

With reference now to FIG. 3, FIG. 3 is a data flow diagram illustrating an example of a process 300 for training one or more machine learning models 302, in accordance with some embodiments of the present disclosure. In some examples, the machine learning model(s) 302 may correspond to the language model(s) 106. As shown, the machine learning model(s) 302 may be trained using a training dataset 304 (e.g., one or more training datasets) and training inputs 306. The training dataset 304 may include one or more examples of code for controlling various aspects of a simulation and/or interacting and interfacing with a simulation system. For instance, the training dataset 304 may comprise documentation illustrating one or more examples of valid code associated with a simulation system, valid API calls to APIs associated with the simulation system, etc. The training inputs 306 may include specific requests for testing the machine learning model(s) 302 performance. For instance, the training inputs 306 may include a request to generate code to spawn a pedestrian in the simulation environment, code to change the weather of the simulation environment, code to use image data generated from a real vehicle to render a NeRF representation of the real environment for simulation, etc.

The machine learning model(s) 302 may be trained using the training dataset 304, the training inputs 306, as well as corresponding ground truth data 308 (which may correspond to the training dataset 304 and/or the training inputs 306). For instance, if the training inputs 306 includes a request to spawn a pedestrian in the simulation environment, the ground truth data 308 may include valid code for spawning the pedestrian. In some examples, the ground truth data 308 may include annotations, labels, masks, and/or the like. The ground truth data 308 may be generated within a drawing program (e.g., an annotation program), a computer aided design (CAD) program, a labeling program, another type of program suitable for generating the ground truth data 308, and/or may be hand drawn, in some examples. In any example, the ground truth data 308 may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines the location of the labels), and/or a combination thereof (e.g., human identifies vertices of polylines, machine generates polygons using polygon rasterizer).

A training engine 310 may use one or more loss functions that measure loss (e.g., error) in output data 312 (which may be similar to the output data 118) generated by the machine learning model(s) 302 as compared to the ground truth data 308 and/or the training dataset 304. In some examples, the training engine 310 may compare the output data 312 (e.g., a final, code sample) from the machine learning model(s) 302 to the ground truth data 308 that corresponds to one or more of the training inputs 306, and optimize the machine learning model(s) 302 based at least on the comparing. That is, the training engine 310 may update 314 or optimize one or more parameters 316 (e.g., weights, biases, etc.) associated with the machine learning model(s) 302 to reduce the losses/differences between the output data 312 and the ground truth data 308 and/or the training dataset 304. Any type of loss function may be used, such as cross entropy loss, mean squared error, mean absolute error, mean bias error, and/or other loss function types. In some examples, different outputs may have different loss functions. In such examples, the loss functions may be combined to form a total loss, and the total loss may be used to train (e.g., update the parameters of) the machine learning model(s) 302.

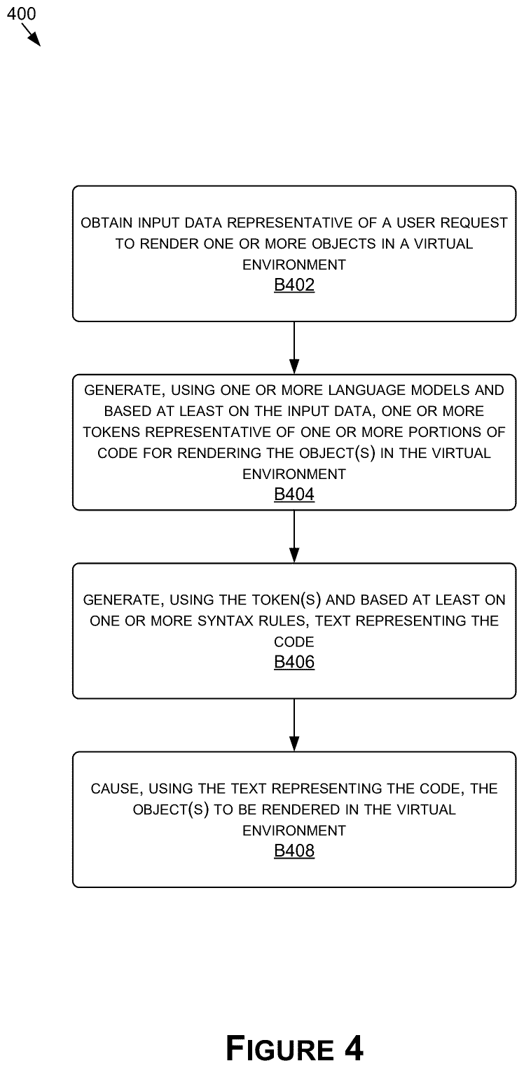

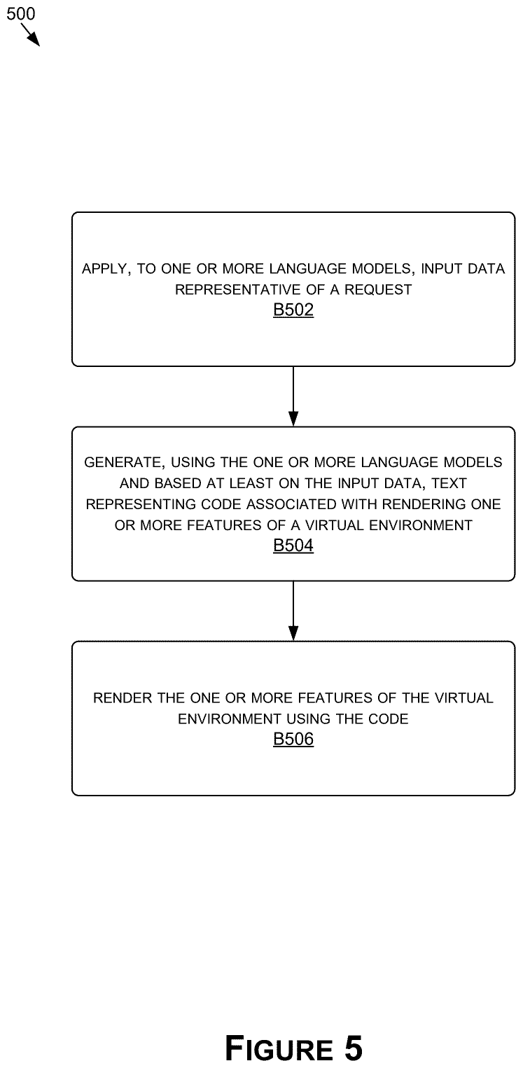

Now referring to FIGS. 4-5, each block of methods 400 and 500, described herein, comprises a computing process that may be performed using any combination of hardware, firmware, and/or software. For instance, various functions may be carried out using one or more processors executing instructions stored in one or more memories. The methods may also be embodied as computer-usable instructions stored on computer storage media. The methods may be provided by a standalone application, a service or hosted service (standalone or in combination with another hosted service), as a microservice via an application programming interface (API) or a plug-in to another product, to name a few. In addition, methods 400 and 500 are described, by way of example, with respect to the system of FIG. 1. However, these methods may additionally or alternatively be executed by any one system, or any combination of systems, including, but not limited to, those described herein.

FIG. 4 is a flow diagram illustrating an example of a method 400 for using a language model to render objects in a virtual environment, in accordance with some embodiments of the present disclosure. The method 400, at block B402, includes obtaining input data representative of a user request to render one or more objects in a virtual environment. For instance, the language model(s) 106 may obtain the input data 116 representative of the user request to render the object(s) in the virtual environment.

The method 400, at block B404, includes generating, using one or more language models and based at least on the input data, one or more tokens representative of one or more portions of code for rendering the one or more objects in the virtual environment. For instance, the language model(s) may generate the token(s) representative of the portions of code for rendering the object(s) in the virtual environment.

The method 400, at block B406, includes generating, using the one or more tokens and based at least on one or more syntax rules, text representing the code. For instance, the language model(s) 106 may generate the text representing the code using the token(s) and based on the syntax rule(s). That is, the language model(s) 106 may format or arrange the text/tokens using the syntax rule(s) so that the text represents valid code for rendering the object(s). In some examples, the syntax rule(s) may correspond to a programming language used by the simulation system 110. For instance, the simulation system 110 may use a TOML or Python programming language, and the syntax rule(s) may correspond to TOML or Python syntax rules.

In some examples, for the language model(s) to generate the text representing the code, the system(s) of the present disclosure may feed into the language model(s) documentation and/or examples of code for controlling aspects of a simulation environment. For instance, this data may include examples of code for rendering objects in the environment having various attributes. Additionally, this data may include examples of code or API calls to change weather conditions in the simulation environment, change behaviors of simulated agents in the simulation, etc. By feeding this data into the language model(s), the language model(s) may be able to draw associations between the examples in the documentation and the request/query submitted to it. In this way, as developers make changes to their own systems (e.g., the simulation system, the code/syntax for controlling the simulation system, etc.), the developers may not need to retrain the model(s) each time updates or changes are made. Instead, the model(s) may be shown updated examples, and the model(s) may learn to produce outputs based on these examples, without specialized training.

The method 400, at block B408, includes causing, using the text representing the code, the one or more objects to be rendered in the virtual environment. For instance, the API(s) 108 and/or the simulation system 110 may use the text representing the code (e.g., the output data 118) to cause the object(s) to be rendered in the virtual environment. For instance, the simulation system 110 may execute the code, which may cause the object(s) to be rendered or spawned in the virtual environment. In some examples, the code may specify the behavior, appearance, etc. of certain objects (e.g., virtual agents), and the simulation system 110, by executing the code, may generate simulation output(s) 120 that include the objects behaving, appearing, etc. according to parameters in the code, or parameters specified in the initial request.

FIG. 5 is a flow diagram illustrating an example of a method 500 for using a language model to generate a virtual environment, in accordance with some embodiments of the present disclosure. The method 500, at block B502, includes applying, to one or more language models, input data representative of a request. For instance, the input data 116 may be applied to the language model(s) 106.

The method 500, at block B504, includes generating, using the one or more language models and based at least on the input data, text representing code associated with rendering one or more features of a virtual environment. For instance, the language model(s) 106 may generate text representing code associated with rendering one or more features of the virtual environment. In some examples, the text may be included in the output data 118. In some examples, the feature(s) of the virtual environment may include, but is not limited to, terrain, objects, virtual agents, pedestrians, vehicles, buildings, roads, curbs, barriers, lane markings, signs, trees, rocks, or any other features that may be included in a virtual environment.

The method 500, at block B506, includes render the one or more features of the virtual environment using the code. For instance, the API(s) 108 and/or the simulation system 110 may render the feature(s) of the virtual environment using the code. In some examples, the simulation system 110 may execute the code and produce the simulation output(s) 120. In some examples, the simulation output(s) 120 may include image frames (e.g., frames of a simulation) depicting the feature(s) of the virtual environment.

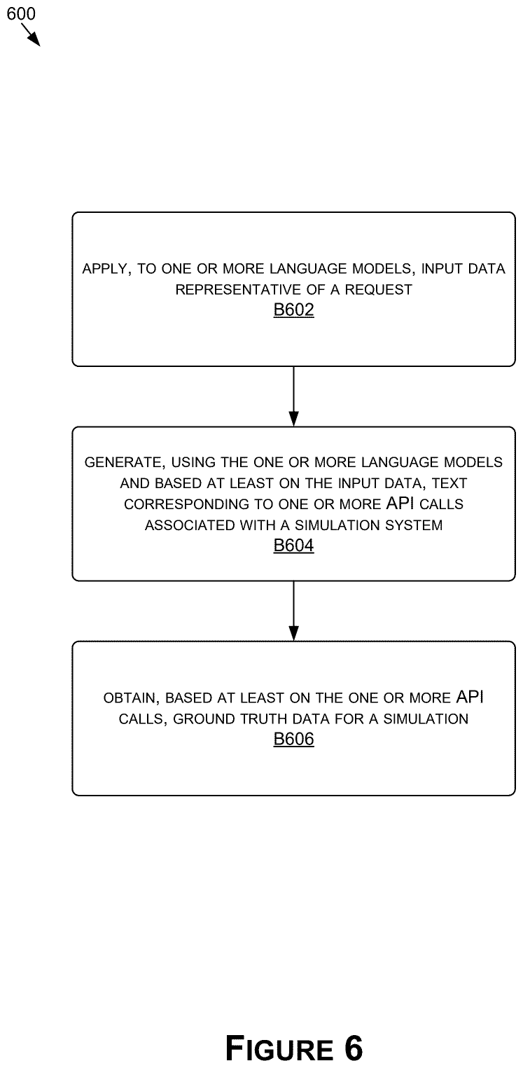

FIG. 6 is a flow diagram illustrating an example of a method 600 for using a language model to generate ground truth data from a simulation, in accordance with some embodiments of the present disclosure. The method 600, at block B602, includes applying, to one or more language models, input data representative of a request. For instance, the input data 116 may be applied to the language model(s) 106.

The method 600, at block B604, includes generating, using the language model(s) and based at least on the input data, text corresponding to one or more API calls associated with a simulation system. For instance, the language model(s) 106 may generate the text corresponding to the API calls based on the input data. In some examples, the text may be representative of code (e.g., human readable or machine readable code) that includes or makes the one or more API calls. That is, the text may represent the code including the API calls, and when a computing device executes the code the computing device may make the API call in accordance with the text.

The method 600, at block B606, includes obtaining, based at least on the API calls, ground truth data for a simulation. For instance, the API calls may include API calls to a ground truth API associated with the simulation system 110. The ground truth API may be configured to, among other things, generate outputs indicating occupancy voxels and/or other ground truth labels associated with the simulation. The ground truth data may be used for training one or more machine learning models and/or other algorithms. For instance, the ground truth data may correspond to the ground truth data 308.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models—such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types.

Various types of LLMs/VLMs/MMLMs/etc. architectures may be implemented in various embodiments. For example, different architectures may be implemented that use different techniques for understanding and generating outputs—such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type—including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources—such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 7A is a block diagram of an example generative language model system 700 suitable for use in implementing at least some embodiments of the present disclosure. In the example illustrated in FIG. 7A, the generative language model system 700 includes a retrieval augmented generation (RAG) component 792, an input processor 705, a tokenizer 710, an embedding component 720, plug-ins/APIs 795, and a generative language model (LM) 730 (which may include an LLM, a VLM, a multi-modal LM, etc.).

At a high level, the input processor 705 may receive an input 701 comprising text and/or other types of input data (e.g., audio data, video data, image data, sensor data (e.g., LiDAR, RADAR, ultrasonic, etc.), 3D design data, CAD data, universal scene descriptor (USD) data—such as OpenUSD, etc.), depending on the architecture of the generative LM 730 (e.g., LLM/VLM/MMLM/etc.). In some embodiments, the input 701 includes plain text in the form of one or more sentences, paragraphs, and/or documents. Additionally or alternatively, the input 701 may include numerical sequences, precomputed embeddings (e.g., word or sentence embeddings), and/or structured data (e.g., in tabular formats, JSON, or XML). In some implementations in which the generative LM 730 is capable of processing multi-modal inputs, the input 701 may combine text (or may omit text) with image data, audio data, video data, design data, USD data, and/or other types of input data, such as but not limited to those described herein. Taking raw input text as an example, the input processor 705 may prepare raw input text in various ways. For example, the input processor 705 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 705 may remove stopwords to reduce noise and focus the generative LM 730 on more meaningful content. The input processor 705 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 792 (which may include one or more RAG models, and/or may be performed using the generative LM 730 itself) may be used to retrieve additional information to be used as part of the input 701 or prompt. RAG may be used to enhance the input to the LLM/VLM/MMLM/etc. with external knowledge, so that answers to specific questions or queries or requests are more relevant—such as in a case where specific knowledge is required. The RAG component 792 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model. For instance, the additional information and the original input or prompt to the LLM may be concatenated together and then fed into the LLM. Additionally, or alternatively, the original input may be updated using the additional information (e.g., updated with additional context, words, etc. to create a more complete query/prompt).

For example, in some embodiments, the input 701 may be generated using the query or input to the model (e.g., a question, a request, etc.) in addition to data retrieved using the RAG component 792. In some embodiments, the input processor 705 may analyze the input 701 and communicate with the RAG component 792 (or the RAG component 792 may be part of the input processor 705, in embodiments) in order to identify relevant text and/or other data to provide to the generative LM 730 as additional context or sources of information from which to identify the response, answer, or output 790, generally. For example, where the input indicates that the user is interested in a desired tire pressure for a particular make and model of vehicle, the RAG component 792 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 792 may retrieve a prior stored conversation history—or at least a summary thereof—and include the prior conversation history along with the current ask/request as part of the input 701 to the generative LM 730.

The RAG component 792 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 792 and the embeddings of the chunks along with the embeddings of the query may be compared to identify the most similar/related embeddings to the query, which may be supplied to the generative LM 730 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 792 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 710 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 730 to understand morphological variations and handle out-of-vocabulary words more effectively. Character-based tokenization represents each character as a separate token, enabling the generative LM 730 to process text at a fine-grained level. The choice of tokenization strategy may depend on factors such as the language being processed, the task at hand, and/or characteristics of the training dataset. As such, the tokenizer 710 may convert the (e.g., processed) text into a structured format according to tokenization schema being implemented in the particular embodiment.

The embedding component 720 may use any known embedding technique to transform discrete tokens into (e.g., dense, continuous vector) representations of semantic meaning. For example, the embedding component 720 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 701 includes image data/video data/etc., the input processor 701 may resize the data to a standard size compatible with format of a corresponding input channel and/or may normalize pixel values to a common range (e.g., 0 to 1) to ensure a consistent representation, and the embedding component 720 may encode the image data using any known technique (e.g., using one or more convolutional neural networks (CNNs) to extract visual features). In some implementations in which the input 701 includes audio data, the input processor 701 may resample an audio file to a consistent sampling rate for uniform processing, and the embedding component 720 may use any known technique to extract and encode audio features—such as in the form of a spectrogram (e.g., a mel-spectrogram). In some implementations in which the input 701 includes video data, the input processor 701 may extract frames or apply resizing to extracted frames, and the embedding component 720 may extract features such as optical flow embeddings or video embeddings and/or may encode temporal information or sequences of frames. In some implementations in which the input 701 includes multi-modal data, the embedding component 720 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 730 and/or other components of the generative LM system 700 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 720 may apply an encoded representation of the input 701 to the generative LM 730, and the generative LM 730 may process the encoded representation of the input 701 to generate an output 790, which may include responsive text and/or other types of data.

As described herein, in some embodiments, the generative LM 730 may be configured to access or use—or capable of accessing or using—plug-ins/APIs 795 (which may include one or more plug-ins, application programming interfaces (APIs), databases, data stores, repositories, etc.). For example, for certain tasks or operations that the generative LM 730 is not ideally suited for, the model may have instructions (e.g., as a result of training, and/or based on instructions in a given prompt, such as those retrieved using the RAG component 792) to access one or more plug-ins/APIs 795 (e.g., 3rd party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 795 to the plug-in/API 795, the plug-in/API 795 may process the information and return an answer to the generative LM 730, and the generative LM 730 may use the response to generate the output 790. This process may be repeated—e.g., recursively—for any number of iterations and using any number of plug-ins/APIs 795 until an output 790 that addresses each ask/question/request/process/operation/etc. from the input 701 can be generated. As such, the model(s) may not only rely on its own knowledge from training on a large dataset(s) and/or from data retrieved using the RAG component 792, but also on the expertise or optimized nature of one or more external resources—such as the plug-ins/APIs 795.

FIG. 7B is a block diagram of an example implementation in which the generative LM 730 includes a transformer encoder-decoder. For example, assume input text such as “Who discovered gravity” is tokenized (e.g., by the tokenizer 710 of FIG. 7A) into tokens such as words, and each token is encoded (e.g., by the embedding component 720 of FIG. 97A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 735 of the generative LM 730.

In an example implementation, the encoder(s) 735 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 740 may convert the context vector into attention vectors (keys and values) for the decoder(s) 745.

In an example implementation, the decoder(s) 745 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 735, in an example transformer architecture, each token (e.g., word) flows through a separate path in the decoder(s) 745. During a first pass, the decoder(s) 745, a classifier 750, and a generation mechanism 755 may generate a first token, and the generation mechanism 755 may apply the generated token as an input during a second pass. The process may repeat in a loop, successively generating and adding tokens (e.g., words) to the output from the preceding pass and applying the token embeddings of the composite sequence with positional encodings as an input to the decoder(s) 745 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 735, except that it creates its queries from the layer below it and takes the keys and values (e.g., matrix) from the output of the encoder(s) 735.

As such, the decoder(s) 745 may output some decoded (e.g., vector) representation of the input being applied during a particular pass. The classifier 750 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 755 may select or sample a word or token based on a corresponding predicted probability (e.g., select the word with the highest predicted probability) and append it to the output from a previous pass, generating each word or token sequentially. The generation mechanism 755 may repeat the process, triggering successive decoder inputs and corresponding predictions until selecting or sampling a symbol or token that represents the end of the response, at which point, the generation mechanism 755 may output the generated response.

FIG. 7C is a block diagram of an example implementation in which the generative LM 730 includes a decoder-only transformer architecture. For example, the decoder(s) 760 of FIG. 7C may operate similarly as the decoder(s) 745 of FIG. 7B except each of the decoder(s) 760 of FIG. 7C omits the encoder-decoder self-attention layer (since there is no encoder in this implementation). As such, the decoder(s) 760 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 760. As with the decoder(s) 745 of FIG. 7B, each token (e.g., word) may flow through a separate path in the decoder(s) 760, and the decoder(s) 760, a classifier 765, and a generation mechanism 770 may use auto-regression to sequentially generate one token at a time until predicting a symbol or token that represents the end of the response. The classifier 765 and the generation mechanism 770 may operate similarly as the classifier 750 and the generation mechanism 755 of FIG. 7B, with the generation mechanism 770 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Simulation Systems

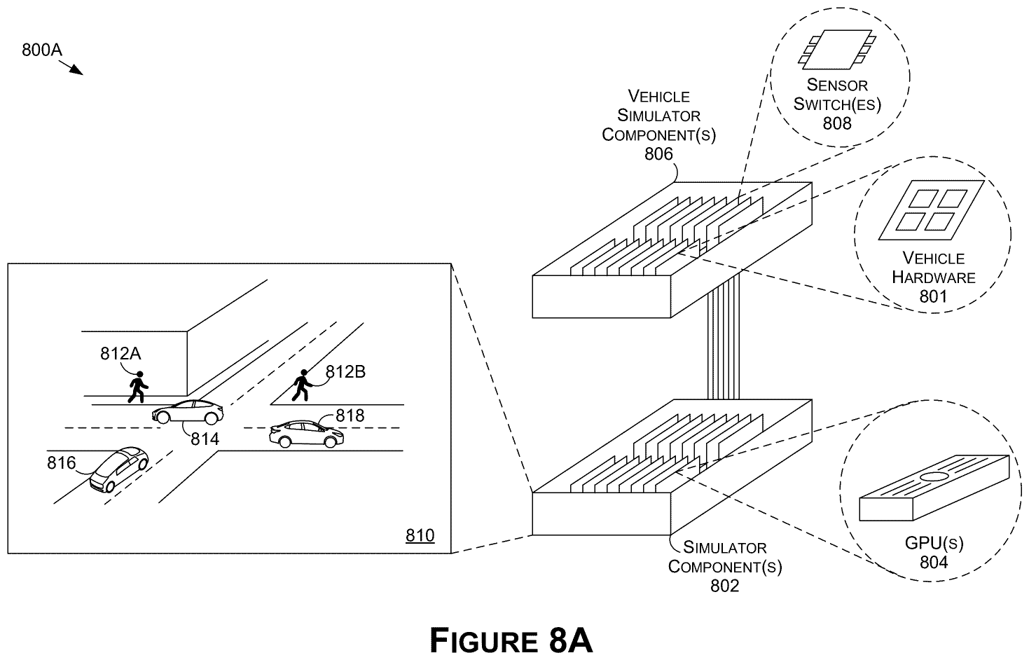

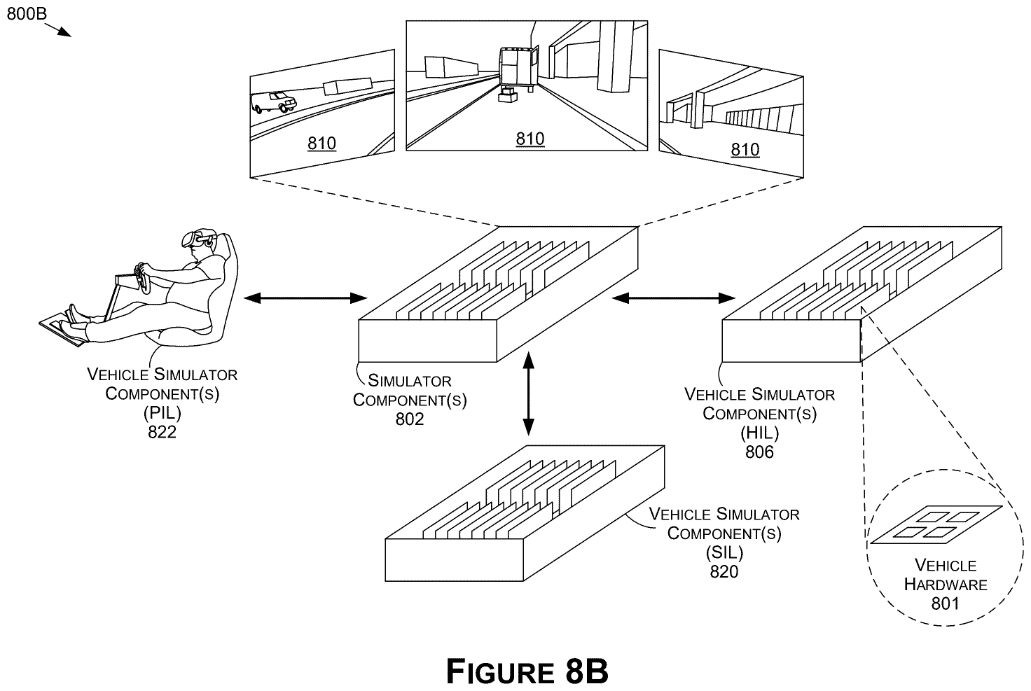

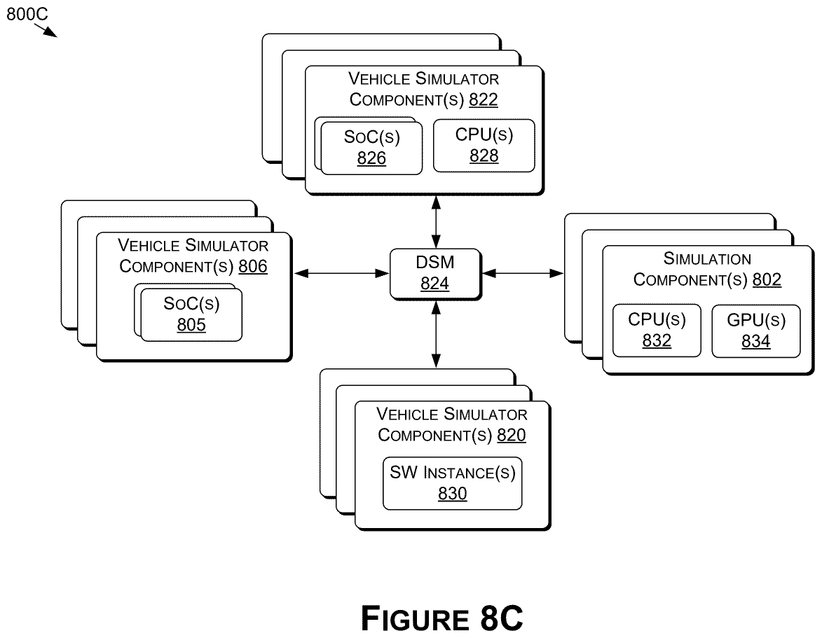

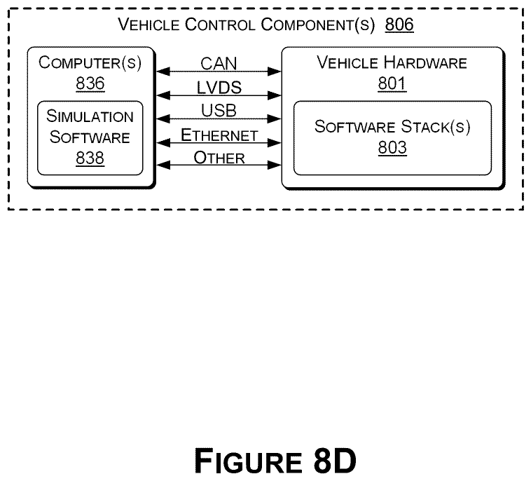

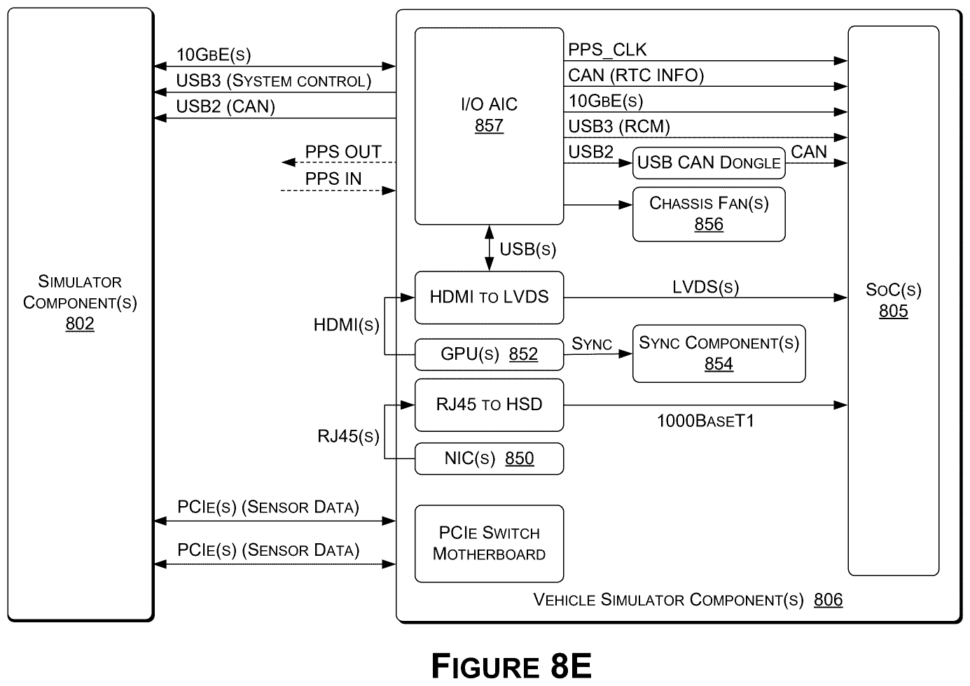

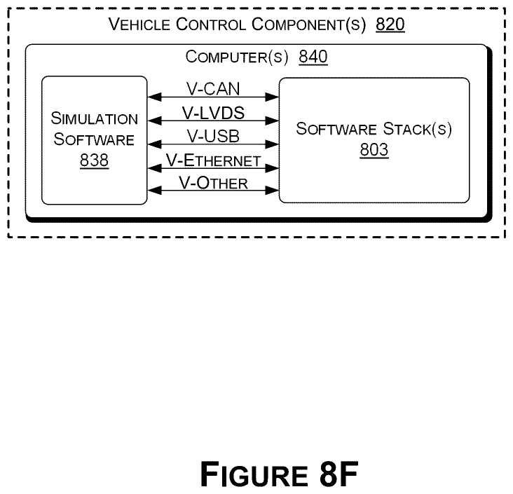

In some embodiments, various aspects of the present disclosure may be used in a simulated environment to test one or more autonomous or semi-autonomous driving software stacks. For example, the simulation system 800—e.g., represented by simulation systems 800A, 800B, 800C, and 800D in FIGS. 8A-8D, and described in more detail below—may generate a global simulation that simulates a virtual world or environment (e.g., a simulated environment) that may include artificial intelligence (AI) vehicles or other objects (e.g., pedestrians, animals, etc.), hardware-in-the-loop (HIL) vehicles or other objects, software-in-the-loop (SIL) vehicles or other objects, and/or person-in-the-loop (PIL) vehicles or other objects. The simulated driving platform system 900 may be implemented at least in part based on simulation systems 800. The global simulation may be maintained within an engine (e.g., a game engine), or other software-development environment, that may include a rendering engine (e.g., for 2D and/or 3D graphics), a physics engine (e.g., for collision detection, collision response, etc.), sound, scripting, animation, AI, networking, streaming, memory management, threading, localization support, scene graphs, cinematics, and/or other features. In some examples, as described herein, one or more vehicles or objects within the simulation system 800 (e.g., HIL objects, SIL objects, PIL objects, AI objects, etc.) may be maintained within their own instance of the engine. In such examples, a virtual sensor for each virtual object may include its own instance of the engine (e.g., an instance for a virtual camera, a second instance for a virtual LIDAR sensor, a third instance for another virtual LIDAR sensor, etc.). As such, an instance of the engine may be used for processing sensor data for each virtual sensor with respect to the virtual sensor's perception of the global simulation. As such, for a virtual camera, the instance may be used for processing image data with respect to the virtual camera's field of view in the simulated environment. As another example, for an virtual IMU sensor, the instance may be used for processing IMU data (e.g., representative of orientation) for the object in the simulated environment.

AI controlled agents (e.g., one or more independent ego agents discussed herein) or other objects within a simulation may include pedestrians, animals, third-party vehicles, vehicles, and/or other object types. The agents executed within the simulated environment may be controlled using artificial intelligence (e.g., machine learning such as neural networks, rules-based control, a combination thereof, etc.) in a way that simulates, or emulates, how corresponding real-world objects would behave. In some examples, the rules, or actions, for agents may be learned from one or more HIL objects, SIL objects, and/or PIL objects. In an example where an agent in the simulated environment corresponds to a pedestrian, the bot may be trained to act like a pedestrian in any of a number of different situations or environments (e.g., running, walking, jogging, not paying attention, on the phone, raining, snowing, in a city, in a suburban area, in a rural community, etc.). As such, when the simulated environment is used for testing vehicle performance (e.g., for HIL or SIL embodiments), the bot (e.g., the pedestrian) may behave as a real-world pedestrian would (e.g., by jaywalking in rainy or dark conditions, failing to heed stop signs or traffic lights, etc.), in order to more accurately simulate a real-world environment. This method may be used for any agent in the simulated environment, such as vehicles, bicyclists, or motorcycles, whose agents may also be trained to behave as real-world objects would (e.g., weaving in and out of traffic, swerving, changing lanes with no signal or suddenly, braking unexpectedly, etc.).

The AI objects that may be distant from the vehicle of interest (e.g., the ego-vehicle in the simulated environment) may be represented in a simplified form—such as a radial distance function, or list of points at known positions in a plane, with associated instantaneous motion vectors. As such, the AI objects may be modeled similarly to how AI agents may be modeled in videogame engines.

HIL vehicles or objects may use hardware that is used in the physical vehicles or objects to at least assist in some of the control of the HIL vehicles or objects in the simulated environment. For example, a vehicle controlled in a HIL environment may use one or more SoCs 194 (FIG. 11C), CPU(s) 1118, GPU(s) 1120, etc., in a data flow loop for controlling the vehicle in the simulated environment. In some examples, the hardware from the vehicles may be an NVIDIA DRIVE AGX Pegasus™ compute platform and/or an NVIDIA DRIVE PX Xavier™ compute platform. For example, the vehicle hardware (e.g., vehicle hardware 801) may include some or all of the components and/or functionality described in U.S. Non-Provisional application Ser. No. 16/186,473, filed on Nov. 8, 2018, which is hereby incorporated by reference in its entirety. In such examples, at least some of the control decisions may be generated using the hardware that is configured for installation within a real-world autonomous vehicle (e.g., the vehicle 190) to execute at least a portion of a software stack(s) 803 (e.g., an autonomous driving software stack).

SIL vehicles or objects may use software to simulate or emulate the hardware from the HIL vehicles or objects. For example, instead of using the actual hardware that may be configured for use in physical vehicles (e.g., the vehicle 190), software, hardware, or a combination thereof may be used to simulate or emulate the actual hardware (e.g., simulate the SoC(s) 194).

PIL vehicles or objects may use one or more hardware components that allow a remote operator (e.g., a human, a robot, etc.) to control the PIL vehicle or object within the simulated environment. For example, a person or robot may control the PIL vehicle using a remote control system (e.g., including one or more pedals, a steering wheel, a VR system, etc.), such as the remote control system described in U.S. Non-Provisional application Ser. No. 16/366,506, filed on Mar. 27, 2018, and hereby incorporated by reference in its entirety. In some examples, the remote operator may control autonomous driving level 0, 1, or 2 (e.g., according to the Society of Automotive Engineers document J3016) virtual vehicles using a VR headset and a CPU(s) (e.g., an X86 processor), a GPU(s), or a combination thereof. In other examples, the remote operator may control advanced AI-assisted level 2, 3, or 4 vehicles modeled using one or more advanced SoC platforms. In some examples, the PIL vehicles or objects may be recorded and/or tracked, and the recordings and/or tracking data may be used to train or otherwise at least partially contribute to the control of AI objects, such as those described herein.

Now referring to FIG. 8A, FIG. 8A is an example illustration of a simulation system 800A, in accordance with some embodiments of the present disclosure. The simulation system 800A may generate a simulated environment 810 (e.g., a simulated driving environment as discussed herein) that may include agents such as AI objects 812 (e.g., AI objects 812A and 812B), HIL objects 814, SIL objects 816, PIL objects 818, and/or other object types. The simulated environment 810 may include features of a driving environment, such as roads, bridges, tunnels, street signs, stop lights, crosswalks, buildings, trees and foliage, the sun, the moon, reflections, shadows, etc., in an effort to simulate a real-world environment accurately within the simulated environment 810. In some examples, the features of the driving environment within the simulated environment 810 may be more true-to-life by including chips, paint, graffiti, wear and tear, damage, etc. Although described with respect to a driving environment, this is not intended to be limiting, and the simulated environment may include an indoor environment (e.g., for a robot, a drone, etc.), an aerial environment (e.g., for a UAV, a drone, an airplane, etc.), an aquatic environment (e.g., for a boat, a ship, a submarine, etc.), and/or another environment type.

The simulated environment 810 may be generated using virtual data, real-world data, or a combination thereof. For example, the simulated environment may include real-world data augmented or changed using virtual data to generate combined data that may be used to simulate certain scenarios or situations with different and/or added elements (e.g., additional AI objects, environmental features, weather conditions, etc.). For example, pre-recorded video may be augmented or changed to include additional pedestrians, obstacles, and/or the like, such that the virtual objects (e.g., executing the software stack(s) 803 as HIL objects and/or SIL objects) may be tested against variations in the real-world data. In some embodiments, the simulated environment 810 may comprise a NeRF representation of a real environment captured in image data.

The simulated environment may be generated using rasterization, ray-tracing, using DNNs such as generative adversarial networks (GANs), another rendering technique, and/or a combination thereof. For example, in order to create more true-to-life, realistic lighting conditions (e.g., shadows, reflections, glare, global illumination, ambient occlusion, etc.), the simulation system 800A may use real-time ray-tracing. In one or more embodiments, one or more hardware accelerators may be used by the simulation system 800A to perform real-time ray-tracing. The ray-tracing may be used to simulate LIDAR sensor for accurate generation of LIDAR data. For example, ray casting may be used in an effort to simulate LIDAR reflectivity. In another example, virtual LIDAR data may be generated using a learned sensor model, as described in more detail above. In any example, ray-tracing techniques used by the simulation system 800A may include one or more techniques described in U.S. Provisional Patent Application No. 62/644,385, filed Mar. 17, 2018, U.S. Provisional Patent Application No. 62/644,386, filed Mar. 17, 2018, U.S. Provisional Patent Application No. 62/644,601, filed Mar. 18, 2018, and U.S. Provisional Application No. 62/644,806, filed Mar. 18, 2018, U.S. Non-Provisional patent application Ser. No. 16/354,883, filed on Mar. 15, 2018, and/or U.S. Non-Provisional patent application Ser. No. 16/355,214, filed on Mar. 15, 2018, each of which is hereby incorporated by reference in its entirety.

In some examples, a simulated environment as described herein (e.g., by simulated driving platform system 90) may be rendered, at least in part, using one or more DNNs, such as generative adversarial neural networks (GANs). For example, real-world data may be collected, such as real-world data captured by autonomous vehicles (e.g., camera(s), LIDAR sensor(s), RADAR sensor(s), etc.), robots, and/or other objects, as well as real-world data that may be captured by any sensors (e.g., images or video pulled from data stores, online resources such as search engines, etc.). The real-world data may then be segmented, classified, and/or categorized, such as by labeling differing portions of the real-world data based on class (e.g., for an image of a landscape, portions of the image—such as pixels or groups of pixels—may be labeled as car, sky, tree, road, building, water, waterfall, vehicle, bus, truck, sedan, etc.). A GAN (or other DNN or machine learning model) may then be trained using the segmented, classified, and/or categorized data to generate new versions of the different types of objects, landscapes, and/or other features as graphics within the simulated environment.

The simulator component(s) 802 of the simulation system 800 may communicate with vehicle simulator component(s) 806 over a wired and/or wireless connection. In some examples, the connection may be a wired connection using one or more sensor switches 808, where the sensor switches may provide low-voltage differential signaling (LVDS) output. For example, the sensor data (e.g., image data) may be transmitted over an HDMI to LVDS connection between the simulator component(s) 802 and the vehicle simulator component(s) 806. The simulator component(s) 802 may include any number of compute nodes (e.g., computers, servers, etc.) interconnected in order to ensure synchronization of the world state. In some examples, as described herein, the communication between each of the compute nodes (e.g., the vehicle simulator component(s) compute nodes and the simulator component(s) compute nodes) may be managed by a distributed shared memory (DSM) system (e.g., DSM 824 of FIG. 8C) using a distributed shared memory protocol (e.g., a coherence protocol). The DSM may include a combination of hardware (cache coherence circuits, network interfaces, etc.) and software. This shared memory architecture may separate memory into shared parts distributed among nodes and main memory, or distributing all memory between all nodes. In some examples, InfiniBand (IB) interfaces and associated communications standards may be used. For example, the communication between and among different nodes of the simulation system 800 (and/or 900) may use IB.

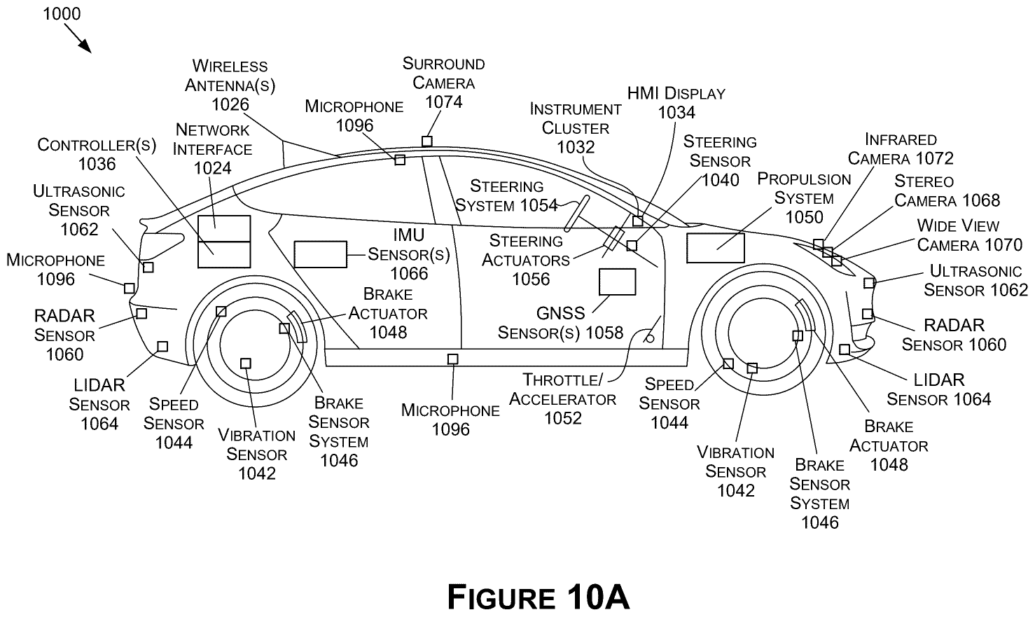

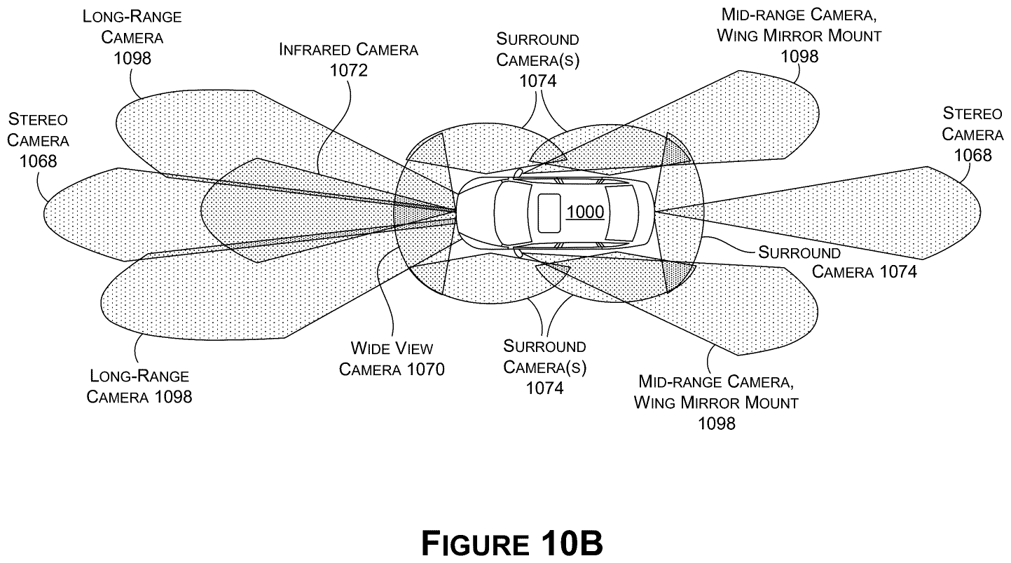

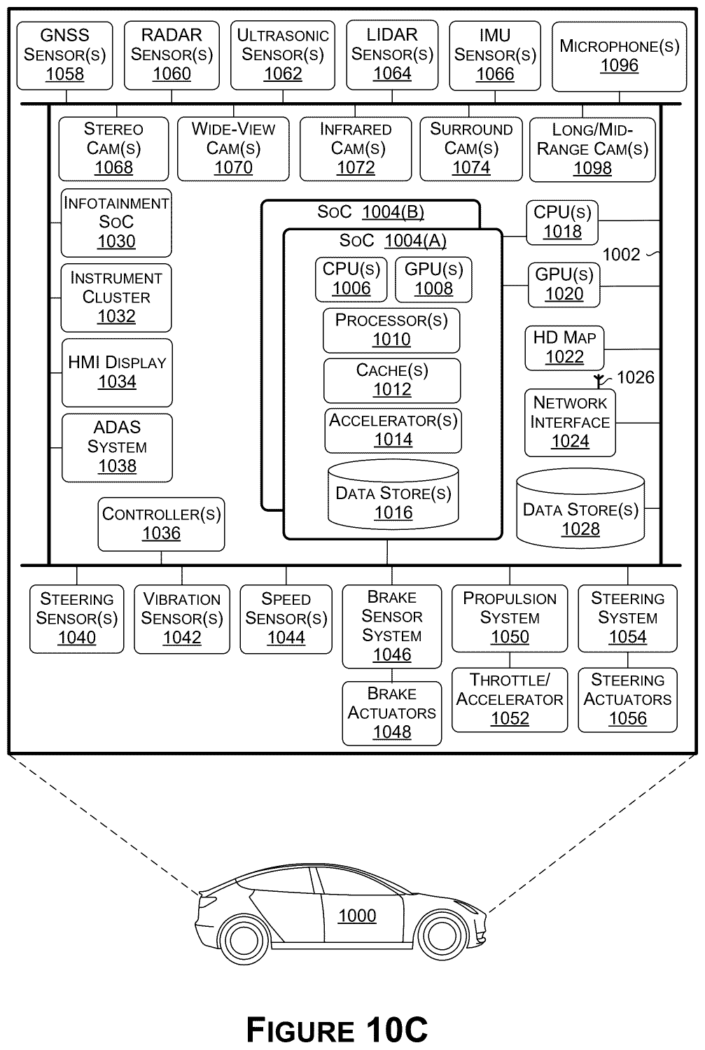

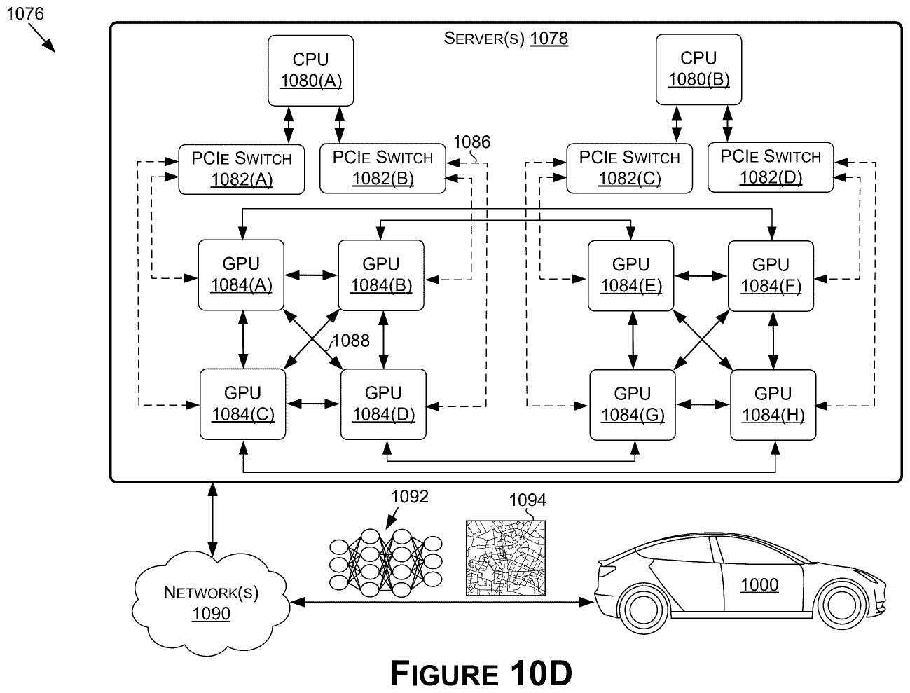

The simulator component(s) 802 may include one or more GPUs 804. The virtual vehicle being simulated may include any number of sensors (e.g., virtual or simulated sensors) that may correspond to one or more of the sensors described herein at least with respect to FIGS. 10A10C. Any or all of the sensors of the simulator component(s) 802 may be implemented using a corresponding learned sensor model, as described in more detail above. In some examples, each sensor of the vehicle may correspond to, or be hosted by, one of the GPUs 804. For example, processing for a LIDAR sensor may be executed on a first GPU 804, processing for a wide-view camera may be executed on a second GPU 804, processing for a RADAR sensor may be executed on a third GPU, and so on. As such, the processing of each sensor with respect to the simulated environment may be capable of executing in parallel with each other sensor using a plurality of GPUs 804 to enable real-time simulation. In other examples, two or more sensors may correspond to, or be hosted by, one of the GPUs 804. In such examples, the two or more sensors may be processed by separate threads on the GPU 804 and may be processed in parallel. In other examples, the processing for a single sensor may be distributed across more than one GPU. In addition to, or alternatively from, the GPU(s) 804, one or more TPUs, CPUs, and/or other processor types may be used for processing the sensor data.

Vehicle simulator component(s) 806 may include a compute node of the simulation system 800A that corresponds to a single vehicle represented in the simulated environment 810. Each other vehicle (e.g., 814, 818, 816, etc.) may include a respective node of the simulation system. As a result, the simulation system 800A may be scalable to any number of vehicles or objects as each vehicle or object may be hosted by, or managed by, its own node in the system 800A. In the illustration of FIG. 8A, the vehicle simulator component(s) 806 may correspond to a HIL vehicle (e.g., because the vehicle hardware 801 is used). However, this is not intended to be limiting and, as illustrated in FIGS. 8B and 8C, the simulation system 800 may include SIL vehicles, HIL vehicles, PIL vehicles, and/or AI vehicles. The simulator component(s) 802 (e.g., simulator host device) may include one or more compute nodes of the simulation system 800A, and may host the simulation of the environment with respect to each actor (e.g., with respect to each HIL, SIL, PIL, and AI actors), as well as hosting the rendering and management of the environment or world state (e.g., the road, signs, trees, foliage, sky, sun, lighting, etc.). In some examples, the simulator component(s) 802 may include a server(s) and associated components (e.g., CPU(s), GPU(s), computers, etc.) that may host a simulator (e.g., NVIDIA's DRIVE™ Constellation AV Simulator).

The vehicle hardware 801, as described herein, may correspond to the vehicle hardware that may be used in a physical vehicle 190. However, in the simulation system 800A, the vehicle hardware 801 may be incorporated into the vehicle simulator component(s) 806. As such, because the vehicle hardware 801 may be configured for installation within the vehicle 190, the simulation system 800A may be specifically configured to use the vehicle hardware 801 within a node (e.g., of a server platform) of the simulation system 800A. For example, similar interfaces used in the physical vehicle 190 may need to be used by the vehicle simulator component(s) 806 to communicate with the vehicle hardware 801. In some examples, the interfaces may include: (1) CAN interfaces, including a PCAN adapter, (2) Ethernet interfaces, including RAW UDP sockets with IP address, origin, VLA, and/or source IP all preserved, (3) Serial interfaces, with a USB to serial adapter, (4) camera interfaces, (5) InfiniBand (IB) interfaces, and/or other interface types.

In examples, once the sensor data representative of a field(s) of view of the sensor(s) of the vehicle in the simulated environment has been generated and/or processed (e.g., using one or more codecs, as described herein), the sensor data (and/or encoded sensor data) may be used by the software stack(s) 803 (e.g., the autonomous driving software stack) executed on the vehicle hardware 801 to perform one or more operations (e.g., generate one or more controls, route planning, detecting objects, identifying drivable free-space, monitoring the environment for obstacle avoidance, etc.). As a result, the identical, or substantially identical, hardware components used by the vehicle 190 (e.g., a physical vehicle) to execute the autonomous driving software stack in real-world environments may be used to execute the autonomous driving software stack in the simulated environment 810. The use of the vehicle hardware 801 in the simulation system 800A thus provides for a more accurate simulation of how the vehicle 190 will perform in real-world situations, scenarios, and environments without having to actually find and test the vehicle 190 in the real-world. This may reduce the amount of driving time required for testing the hardware/software combination used in the physical vehicle 190 and may reduce safety risks by not requiring actual real-world testing (especially for dangerous situations, such as other vehicles driving erratically or at unsafe speeds, children playing in the street, ice on a bridge, etc.).

In addition to the vehicle hardware 801, the vehicle simulator component(s) 806 may manage the simulation of the vehicle (or other object) using additional hardware, such as a computer —e.g., an X86 box. In some examples, additional processing for virtual sensors (e.g., learned sensor models) of the virtual object may be executed using the vehicle simulation component(s) 806. In such examples, at least some of the processing may be performed by the simulator component(s) 802, and other of the processing may be executed by the vehicle simulator component(s) 806 (or 820, or 822, as described herein). In other examples, the processing of the virtual sensors may be executed entirely on the vehicle simulator component(s) 806.

Now referring to FIG. 8B, FIG. 8B is another example illustration of a simulation system 800B, in accordance with some embodiments of the present disclosure. The simulation system 800B may include the simulator component(s) 802 (as one or more compute nodes), the vehicle simulator component(s) 806 (as one or more compute nodes) for a HIL object(s), the vehicle simulator component(s) 820 (as one or more compute nodes) for a SIL object(s), the vehicle simulator component(s) 806 (as one or more compute nodes) for a PIL object(s), and/or additional component(s) (or compute nodes) for AI objects and/or other object types. Each of the PIL, HIL, SIL, AI, and/or other object type compute nodes may communicate with the simulator component(s) 802 to capture from the global simulation at least data that corresponds to the respective object within the simulate environment 810.

For example, the vehicle simulator component(s) 822 may receive (e.g., retrieve, obtain, etc.), from the global simulation (e.g., represented by the simulated environment 810) hosted by the simulator component(s) 802, data that corresponds to, is associated with, and/or is required by the vehicle simulator component(s) 822 to perform one or more operations by the vehicle simulator component(s) 822 for the PIL object. In such an example, data (e.g., virtual sensor data corresponding to a field(s) of view of virtual camera(s) of the virtual vehicle, virtual LIDAR data, virtual RADAR data, virtual location data, virtual IMU data, etc.) corresponding to each sensor of the PIL object may be received from the simulator component(s) 802. This data may be used to generate an instance of the simulated environment corresponding to the field of view of a remote operator of the virtual vehicle controlled by the remote operator, and the portion of the simulated environment may be projected on a display (e.g., a display of a VR headset, a computer or television display, etc.) for assisting the remote operator in controlling the virtual vehicle through the simulated environment 810. The controls generated or input by the remote operator using the vehicle simulator component(s) 822 may be transmitted to the simulator component(s) 802 for updating a state of the virtual vehicle within the simulated environment 810.

As another example, the vehicle simulator component(s) 820 may receive (e.g., retrieve, obtain, etc.), from the global simulation hosted by the simulator component(s) 802, data that corresponds to, is associated with, and/or is required by the vehicle simulator component(s) 820 to perform one or more operations by the vehicle simulator component(s) 820 for the SIL object. In such an example, data (e.g., virtual sensor data corresponding to a field(s) of view of virtual camera(s) of the virtual vehicle, virtual LIDAR data, virtual RADAR data, virtual location data, virtual IMU data, etc.) corresponding to each sensor of the SIL object may be received from the simulator component(s) 802. This data may be used to generate an instance of the simulated environment for each sensor (e.g., a first instance from a field of view of a first virtual camera of the virtual vehicle, a second instance from a field of view of a second virtual camera, a third instance from a field of view of a virtual LIDAR sensor, etc.). The instances of the simulated environment may thus be used to generate sensor data for each sensor by the vehicle simulator component(s) 820. In some examples, the sensor data may be encoded using one or more codecs (e.g., each sensor may use its own codec, or each sensor type may use its own codec) in order to generate encoded sensor data that may be understood or familiar to an autonomous driving software stack simulated or emulated by the vehicle simulator component(s) 820. For example, a first vehicle manufacturer may use a first type of LIDAR data, a second vehicle manufacturer may use a second type of LIDAR data, etc., and thus the codecs may customize the sensor data to the types of sensor data used by the manufacturers. As a result, the simulation system 800 may be universal, customizable, and/or useable by any number of different sensor types depending on the types of sensors and the corresponding data types used by different manufacturers. In any example, the sensor data and/or encoded sensor data may be used by an autonomous driving software stack to perform one or more operations (e.g., object detection, path planning, control determinations, actuation types, etc.). For example, the sensor data and/or encoded data may be used as inputs to one or more DNNs of the autonomous driving software stack, and the outputs of the one or more DNNs may be used for updating a state of the virtual vehicle within the simulated environment 810. As such, the reliability and efficacy of the autonomous driving software stack, including one or more DNNs, may be tested, fine-tuned, verified, and/or validated within the simulated environment.

In yet another example, the vehicle simulator component(s) 806 may receive (e.g., retrieve, obtain, etc.), from the global simulation hosted by the simulator component(s) 802, data that corresponds to, is associated with, and/or is required by the vehicle simulator component(s) 806 to perform one or more operations by the vehicle simulator component(s) 806 for the HIL object. In such an example, data (e.g., virtual sensor data corresponding to a field(s) of view of virtual camera(s) of the virtual vehicle, virtual LIDAR data, virtual RADAR data, virtual location data, virtual IMU data, etc.) corresponding to each sensor of the HIL object may be received from the simulator component(s) 802. This data may be used to generate an instance of the simulated environment for each sensor (e.g., a first instance from a field of view of a first virtual camera of the virtual vehicle, a second instance from a field of view of a second virtual camera, a third instance from a field of view of a virtual LIDAR sensor, etc.). The instances of the simulated environment may thus be used to generate sensor data for each sensor by the vehicle simulator component(s) 820 (e.g., using a corresponding learned sensor model). In some examples, the sensor data may be encoded using one or more codecs (e.g., each sensor may use its own codec, or each sensor type may use its own codec) in order to generate encoded sensor data that may be understood or familiar to an autonomous driving software stack executing on the vehicle hardware 801 of the vehicle simulator component(s) 820. Similar to the SIL object described herein, the sensor data and/or encoded sensor data may be used by an autonomous driving software stack to perform one or more operations (e.g., object detection, path planning, control determinations, actuation types, etc.).

Now referring to FIG. 8C, FIG. 8C is another example illustration of a simulation system 800C, in accordance with some embodiments of the present disclosure. The simulation system 800C may include distributed shared memory (DSM) system 824, the simulator component(s) 802 (as one or more compute nodes), the vehicle simulator component(s) 806 (as one or more compute nodes) for a HIL object(s), the vehicle simulator component(s) 820 (as one or more compute nodes) for a SIL object(s), the vehicle simulator component(s) 806 (as one or more compute nodes) for a PIL object(s), and/or additional component(s) (or compute nodes) for AI objects and/or other object types (not shown). The simulation system 800C may include any number of HIL objects (e.g., each including its own vehicle simulator component(s) 806), any number of SIL objects (e.g., each including its own vehicle simulator component(s) 820), any number of PIL objects (e.g., each including its own vehicle simulator component(s) 822), and/or any number of AI objects (not shown, but may be hosted by the simulation component(s) 802 and/or separate compute nodes, depending on the embodiment).

The vehicle simulator component(s) 806 may include one or more SoC(s) 805 (or other components) that may be configured for installation and use within a physical vehicle. As such, as described herein, the simulation system 800C may be configured to use the SoC(s) 805 and/or other vehicle hardware 801 by using specific interfaces for communicating with the SoC(s) 805 and/or other vehicle hardware. The vehicle simulator component(s) 820 may include one or more software instances 830 that may be hosted on one or more GPUs and/or CPUs to simulate or emulate the SoC(s) 805. The vehicle simulator component(s) 822 may include one or more SoC(s) 826, one or more CPU(s) 828 (e.g., X86 boxes), and/or a combination thereof, in addition to the component(s) that may be used by the remote operator (e.g., keyboard, mouse, joystick, monitors, VR systems, steering wheel, pedals, in-vehicle components, such as light switches, blinkers, HMI display(s), etc., and/or other component(s)).

The simulation component(s) 802 may include any number of CPU(s) 832 (e.g., X86 boxes), GPU(s), and/or a combination thereof. The CPU(s) 832 may host the simulation software for maintaining the global simulation, and the GPU(s) 834 may be used for rendering, physics, and/or other functionality for generating the simulated environment 810.

As described herein, the simulation system 800C may include the DSM 824. The DSM 824 may use one or more distributed shared memory protocols to maintain the state of the global simulation using the state of each of the objects (e.g., HIL objects, SIL objects, PIL objects, AI objects, etc.). As such, each of the compute nodes corresponding to the vehicle simulator component(s) 806, 820, and/or 822 may be in communication with the simulation component(s) 802 via the DSM 824. By using the DSM 824 and the associated protocols, real-time simulation may be possible. For example, as opposed to how network protocols (e.g., TCP, UDP, etc.) are used in massive multiplayer online (MMO) games, the simulation system 800 may use a distributed shared memory protocol to maintain the state of the global simulation and each instance of the simulation (e.g., by each vehicle, object, and/or sensor) in real-time.

Now referring to FIG. 8D, FIG. 8D is an example illustration of a hardware-in-the-loop configuration, in accordance with some embodiments of the present disclosure. The vehicle simulator component(s) 806 may include the vehicle hardware 801, as described herein, and may include one or more computer(s) 836, one or more GPU(s) (not shown), and/or one or more CPU(s) (not shown). The computer(s) 836, GPU(s), and/or CPU(s) may manage or host the simulation software 838, or instance thereof, executing on the vehicle simulator component(s) 806. The vehicle hardware 801 may execute the software stack(s) 803 (e.g., an autonomous driving software stack, an IX software stack, etc.).

As described herein, by using the vehicle hardware 801, the other vehicle simulator component(s) 806 within the simulation environment 800 may need to be configured for communication with the vehicle hardware 801. For example, because the vehicle hardware 801 may be configured for installation within a physical vehicle (e.g., the vehicle 190), the vehicle hardware 801 may be configured to communicate over one or more connection types and/or communication protocols that are not standard in computing environments (e.g., in server-based platforms, in general-purpose computers, etc.). For example, a CAN interface, LVDS interface, USB interface, Ethernet interface, InfiniBand (IB) interface, and/or other interfaces may be used by the vehicle hardware 801 to communicate signals with other components of the physical vehicle. As such, in the simulation system 800, the vehicle simulator component(s) 806 (and/or other component(s) of the simulation system 800 in addition to, or alternative from, the vehicle simulator component(s) 806) may need to be configured for use with the vehicle hardware 801. In order to accomplish this, one or more CAN interfaces, LVDS interfaces, USB interfaces, Ethernet interfaces, and/or other interface may be used to provide for communication (e.g., over one or more communication protocols, such as LVDS) between vehicle hardware 801 and the other component(s) of the simulation system 800.

In some examples, the virtual vehicle that may correspond to the vehicle simulator component(s) 806 within the simulation system 800 may be modeled as a game object within an instance of a game engine. In addition, each of the virtual sensors of the virtual vehicle may be interfaced using sockets within the virtual vehicle's software stack(s) 803 executed on the vehicle hardware 801. In some examples, each of the virtual sensors of the virtual vehicle may include an instance of the game engine, in addition to the instance of the game engine associated with the simulation software 838 for the virtual vehicle. In examples where the vehicle simulator component(s) 806 include a plurality of GPUs, each of the sensors may be executed on a single GPU. In other examples, multiple sensors may be executed on a single GPU, or at least as many sensors as feasible to ensure real-time generation of the virtual sensor data.

Using HIL objects in the simulator system 800 may provide for a scalable solution that may simulate or emulate various driving conditions for autonomous software and hardware systems (e.g., NVIDIA's DRIVE AGX Pegasus™ compute platform and/or DRIVE PX Xavier™ compute platform). Some benefits of HIL objects may include the ability to test DNNs faster than real-time, the ability to scale verification with computing resources (e.g., rather than vehicles or test tracks), the ability to perform deterministic regression testing (e.g., the real-world environment is never the same twice, but a simulated environment can be), optimal ground truth labeling (e.g., no hand-labeling required), the ability to test scenarios difficult to produce in the real-world, rapid generation of test permutations, and the ability to test a larger space of permutations in simulation as compared to real-world.

Now referring to FIG. 8E, FIG. 8E is an example illustration of a hardware-in-the-loop configuration, in accordance with some embodiments of the present disclosure. The HIL configuration of FIG. 8E may include vehicle simulator component(s) 806, including the SoC(s) 805, a chassis fan(s) 856 and/or water-cooling system. The HIL configuration may include a two-box solution (e.g., the simulator component(s) 802 in a first box and the vehicle simulator component(s) 806 in a second box). Using this approach may reduce the amount of space the system occupies as well as reduce the number of external cables in data centers (e.g., by including multiple components together with the SoC(s) 805 in the vehicle simulator component(s) 806—e.g., the first box). The vehicle simulator component(s) 806 may include one or more GPUs 852 (e.g., NVIDIA QUADRO GPU(s)) that may provide, in an example, non-limiting embodiment, 8 DP/HDMI video streams that may be synchronized using sync component(s) 854 (e.g., through a QUADRO Sync II Card). These GPU(s) 852 (and/or other GPU types) may provide the sensor input to the SoC(s) 805 (e.g., to the vehicle hardware 801). In some examples, the vehicle simulator component(s) 806 may include a network interface (e.g., one or more network interface cards (NICs) 850) that may simulate or emulate RADAR sensors, LIDAR sensors, and/or IMU sensors (e.g., by providing 8 Gigabit ports with precision time protocol (PTP) support). In addition, the vehicle simulator component(s) 806 may include an input/output (I/O) analog integrated circuit 857. Registered Jack (RJ) interfaces (e.g., RJ45), high speed data (HSD) interfaces, USB interfaces, pulse per second (PPS) clocks, Ethernet (e.g., 9 Gb Ethernet (GbE)) interfaces, CAN interfaces, HDMI interfaces, and/or other interface types may be used to effectively transmit and communication data between and among the various component(s) of the system.

Now referring to FIG. 8F, FIG. 8F is an example illustration of a software-in-the-loop configuration, in accordance with some embodiments of the present disclosure. The vehicle simulator component(s) 820 may include computer(s) 840, GPU(s) (not shown), CPU(s) (not shown), and/or other components. The computer(s) 840, GPU(s), and/or CPU(s) may manage or host the simulation software 838, or instance thereof, executing on the vehicle simulator component(s) 820, and may host the software stack(s) 803. For example, the vehicle simulator component(s) 820 may simulate or emulate, using software, the vehicle hardware 801 in an effort to execute the software stack(s) 803 as accurately as possible.

In order to increase accuracy in SIL embodiments, the vehicle simulator component(s) 820 may be configured to communicate over one or more virtual connection types and/or communication protocols that are not standard in computing environments. For example, a virtual CAN interface, virtual LVDS interface, virtual USB interface, virtual Ethernet interface, and/or other virtual interfaces may be used by the computer(s) 840, CPU(s), and/or GPU(s) of the vehicle simulator component(s) 820 to provide for communication (e.g., over one or more communication protocols, such as LVDS) between the software stack(s) 803 and the simulation software 838 within the simulation system 800. For example, the virtual interfaces may include middleware that may be used to provide a continuous feedback loop with the software stack(s) 803. As such, the virtual interfaces may simulate or emulate the communications between the vehicle hardware 801 and the physical vehicle using one or more software protocols, hardware (e.g., CPU(s), GPU(s), computer(s) 840, etc.), or a combination thereof.

The computer(s) 840 in some examples, may include X86 CPU hardware, and one or more X86 CPUs may execute both the simulation software 838 and the software stack(s) 803. In other examples, the computer(s) 840 may include GPU hardware (e.g., an NVIDIA DGX system and/or cloud-based NVIDIA Tesla servers).

In some examples, the virtual vehicle that may correspond to the vehicle simulator component(s) 820 within the simulation system 800 may be modeled as a game object within an instance of a game engine. In addition, each of the virtual sensors of the virtual vehicle may be interfaced using sockets within the virtual vehicle's software stack(s) 803 executed on the vehicle simulator component(s) 820. In some examples, each of the virtual sensors of the virtual vehicle may include an instance of the game engine, in addition to the instance of the game engine associated with the simulation software 838 for the virtual vehicle. In examples where the vehicle simulator component(s) 806 include a plurality of GPUs, each of the sensors may be executed on a single GPU. In other examples, multiple sensors may be executed on a single GPU, or at least as many sensors as feasible to ensure real-time generation of the virtual sensor data.

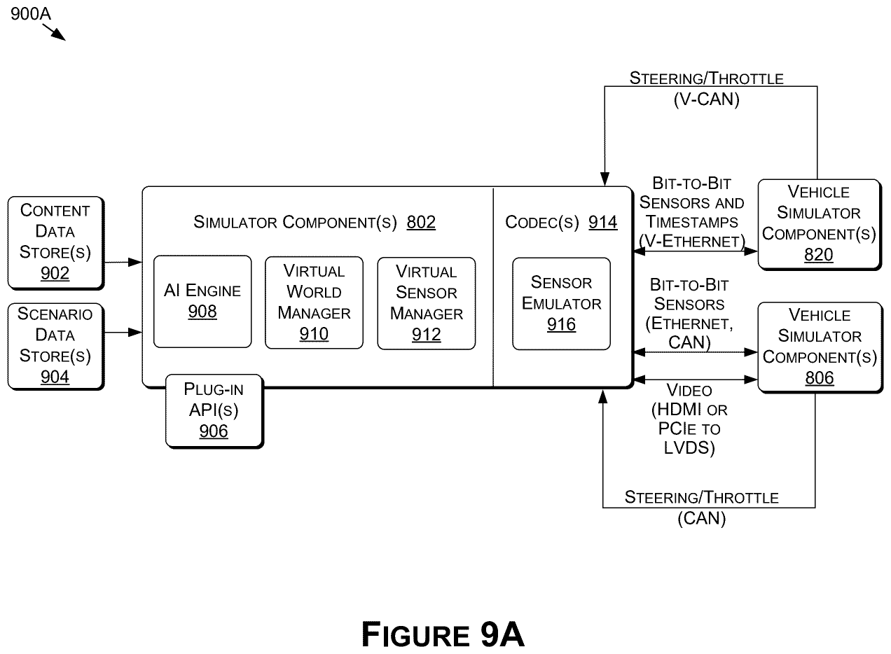

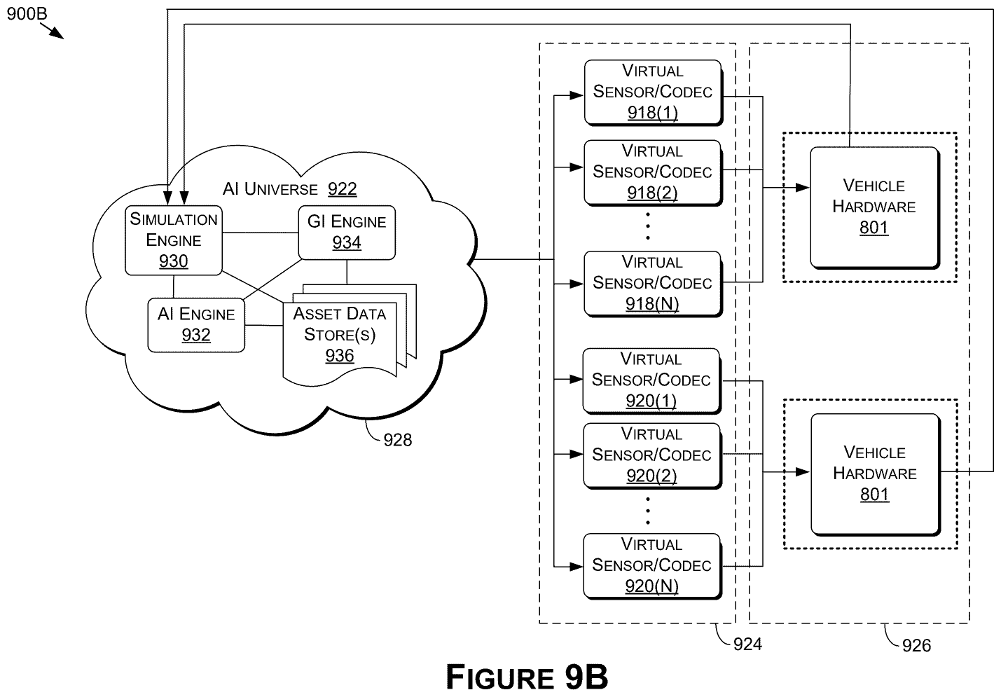

Now referring to FIG. 9A, FIG. 9A is an example illustration of a simulation system 900A at runtime, in accordance with some embodiments of the present disclosure (e.g., simulated driving platform system 900). Some or all of the components of the simulation system 900A may be used in the simulation system 800, and some or all of the components of the simulation system 800 may be used in the simulation system 900A. As such, components, features, and/or functionality described with respect to the simulation system 800 may be associated with the simulation system 900A, and vice versa. In addition, each of the simulation systems 900A and 900B (FIG. 9B) may include similar and/or shared components, features, and/or functionality.

The simulation system 900A (e.g., representing one example of simulation system 900) may include the simulator component(s) 802, codec(s) 914, content data store(s) 902, scenario data store(s) 904, vehicle simulator component(s) 820 (e.g., for a SIL object), and vehicle simulator component(s) 806 (e.g., for a HIL object). The content data store(s) 902 may include detailed content information for modeling cars, trucks, people, bicyclists, signs, buildings, trees, curbs, and/or other features of the simulated environment. The scenario data store(s) 904 may include scenario information that may include dangerous scenario information (e.g., that is unsafe to test in the real-world environment), such as a child in an intersection.

The simulator component(s) 802 may include an AI engine 908 that simulates traffic, pedestrians, weather, and/or other AI features of the simulated environment. The simulator component(s) 802 may include a virtual world manager 910 that manages the world state for the global simulation. The simulator component(s) 802 may further include a virtual sensor manger 912 that may mange the virtual sensors (any or all of which may be implemented using a corresponding learned sensor model). The AI engine 908 may model traffic similar to how traffic is modeled in an automotive video game, and may be done using a game engine, as described herein. In other examples, custom AI may be used to provide the determinism and computational level of detail necessary for large-scale reproducible automotive simulation. In some examples, traffic may be modeled using SIL objects, HIL objects, PIL objects, AI objects, and/or combination thereof. The system 900 may create a subclass of an AI controller that examines map data, computes a route, and drives the route while avoiding other cars. The AI controller may compute desired steering, acceleration, and/or braking, and may apply those values to the virtual objects. The vehicle properties used may include mass, max RPM, torque curves, and/or other properties. A physics engine may be used to determine states of AI objects. As described herein, for vehicles or other objects that may be far away and may not have an impact on a current sensor(s), the system may choose not to apply physics for those objects and only determine locations and/or instantaneous motion vectors. Ray-casting may be used for each wheel to ensure that the wheels of the vehicles are in contact. In some examples, traffic AI may operate according to a script (e.g., rules-based traffic). Traffic AI maneuvers for virtual objects may include lateral lane changes (e.g., direction, distance, duration, shape, etc.), longitudinal movement (e.g., matching speed, relative target, delta to target, absolute value), route following, and/or path following. The triggers for the traffic AI maneuvers may be time-based (e.g., three seconds), velocity-based (e.g., at sixty mph), proximity-based to map (e.g., within twenty feet of intersection), proximity-based to actor (e.g., within twenty feet of another object), lane clear, and/or others.

The AI engine 908 may model pedestrian AI similar to traffic AI, described herein, but for pedestrians. The pedestrians may be modeled similar to real pedestrians, and the system 900 may infer pedestrian conduct based on learned behaviors.

The simulator component(s) 802 may be used to adjust the time of day such that street lights turn on and off, headlights turn on and off, shadows, glares, and/or sunsets are considered, etc. In some examples, only lights within a threshold distance to the virtual object may be considered to increase efficiency.

Weather may be accounted for by the simulator component(s) 802 (e.g., by the virtual world manager 910). The weather may be used to update the coefficients of friction for the driving surfaces, and temperature information may be used to update tire interaction with the driving surfaces. Where rain or snow are present, the system 900 may generate meshes to describe where rainwater and snow may accumulate based on the structure of the scene, and the meshes may be employed when rain or snow are present in the simulation.

In some examples, as described herein, at least some of the simulator component(s) 802 may alternatively be included in the vehicle simulator component(s) 820 and/or 806. For example, the vehicle simulator component(s) 820 and/or the vehicle simulator component(s) 806 may include the virtual sensor manager 912 for managing each of the sensors of the associated virtual object. In addition, one or more of the codecs 914 may be included in the vehicle simulator component(s) 820 and/or the vehicle simulator component(s) 806. In such examples, the virtual sensor manager 912 may generate sensor data corresponding to a sensor of the virtual object (e.g., using a learned sensor model), and the sensor data may be used by sensor emulator 916 of the codec(s) 914 to encode the sensor data according to the sensor data format or type used by the software stack(s) 803 (e.g., the software stack(s) 803 executing on the vehicle simulator component(s) 820 and/or the vehicle simulator component(s) 806).

The codec(s) 914 may provide an interface to the software stack(s) 803. The codec(s) 914 (and/or other codec(s) described herein) may include an encoder/decoder framework. The codec(s) 914 may include CAN steering, throttle requests, and/or may be used to send sensor data to the software stack(s) 803 in SIL and HIL embodiments. The codec(s) 914 may be beneficial to the simulation systems described herein (e.g., 800 and 900). For example, as data is produced by the simulated driving platform system 90 and the simulation systems 800 and 900, the data may be transmitted to the software stack(s) 803 such that the following standards may be met. The data may be transferred to the software stack(s) 803 such that minimal impact is introduced to the software stack(s) 803 and/or the vehicle hardware 801 (in HIL embodiments). This may result in more accurate simulations as the software stack(s) 803 and/or the vehicle hardware 801 may be operating in an environment that closely resembles deployment in a real-world environment. The data may be transmitted to the software stack(s) 803 such that the simulator and/or re-simulator may be agnostic to the actual hardware configuration of the system under test. This may reduce development overhead due to bugs or separate code paths depending on the simulation configuration. The data may be transmitted to the software stack(s) 803 such that the data may match (e.g., bit-to-bit) the data sent from a physical sensor of a physical vehicle (e.g., the vehicle 190). The data may be transmitted to efficiently in both SIL and HIL embodiments.

The sensor emulator 916 may emulate at least cameras, LIDAR sensors, and/or RADAR sensors, any or all of which may be implemented using a corresponding learned sensor model. Using a learned sensor model may obviate the need to model the sensor using ray-tracing, although in some embodiments, ray-tracing may additionally or alternatively be used. With respect to LIDAR sensors, some LIDAR sensors report tracked objects. As such, for each frame represented by the virtual sensor data, the simulator component(s) 802 may create a list of all tracked objects (e.g., trees, vehicles, pedestrians, foliage, etc.) within range of the virtual object having the virtual LIDAR sensors, and may cast virtual rays toward the tracked objects. When a significant number of rays strike a tracked object, that object may be added to the report of the LIDAR data. In some examples, the LIDAR sensors may be modeled using simple ray-casting without reflection, adjustable field of view, adjustable noise, and/or adjustable drop-outs. LIDAR with moving parts, limited fields of view, and/or variable resolutions may be simulated. For example, the LIDAR sensors may be modeled as solid state LIDAR and/or as Optix-based LIDAR. In examples, using Optix-based LIDAR, the rays may bounce from water, reflective materials, and/or windows. Texture may be assigned to roads, signs, and/or vehicles to model laser reflection at the wavelengths corresponding to the textures. RADAR may be implemented similarly to LIDAR. As described herein, RADAR and/or LIDAR may be simulated using learned sensors, ray-tracing techniques, and/or otherwise.

In some examples, the vehicle simulator component(s) 806, 820, and/or 822 may include a feedback loop with the simulator component(s) 802 (and/or the component(s) that generate the virtual sensor data). The feedback loop may be used to provide information for updating the virtual sensor data capture or generation. For example, for virtual cameras, the feedback loop may be based on sensor feedback, such as changes to exposure responsive to lighting conditions (e.g., increase exposure in dim lighting conditions so that the image data may be processed by the DNNs properly). As another example, for virtual LIDAR sensors, the feedback loop may be representative of changes to energy level (e.g., to boost energy to produce more useable or accurate LIDAR data).

GNNS sensors (e.g., GPS sensors) may be simulated within the simulation space to generate real-world coordinates. In order to this, noise functions may be used to approximate inaccuracy. As with any virtual sensors described herein, the virtual sensor data may be generated using a learned sensor model or otherwise, and transmitted to the software stack(s) 803 using the codec(s) 914 to be converted to a bit-to-bit correct signal (e.g., corresponding accurately to the signals generated by the physical sensors of the physical vehicles).

One or more plugin application programming interfaces (APIs) 906 may be used. The plugin APIs 906 may include first-party and/or third-party plugins. For example, third parties may customize the simulation system 900B using their own plugin APIs 906 for providing custom information, such as performance timings, suspension dynamics, tire dynamics, etc.

The plugin APIs 906 may include an ego-dynamics component(s) (not shown) that may receive information from the simulator component(s) 802 including position, velocity, car state, and/or other information, and may provide information to the simulator component(s) 802 including performance timings, suspension dynamics, tire dynamics, and/or other information. For examples, the simulator component(s) 802 may provide CAN throttle, steering, and the driving surface information to the ego-dynamics component(s). In some examples, the ego-dynamics component(s) may include an off-the-shelf vehicle dynamics package (e.g., IPG CARMAKER or VIRTUAL TEST DRIVE), while in other examples the ego-dynamics component(s) may be customized and/or received (e.g., from a first-party and/or a third-party).

The plugin APIs 906 may include a key performance indicator (KPI) API. The KPI API may receive CAN data, ground truth, and/or virtual object state information (e.g., from the software stack(s) 803) from the simulator component(s) 802 and may generate and/or provide a report (in real-time) that includes KPI's and/or commands to save state, restore state, and/or apply changes.

Now referring to FIG. 9B, FIG. 9B includes a cloud-based architecture for a simulation system 900B, in accordance with some embodiment of the present disclosure. The simulation system 900B may, at least partly, reside in the cloud and may communicate over one or more networks, such as but not limited to those described herein (e.g., with respect to network 1180 of FIG. 11D), with one or more GPU platforms 924 (e.g., that may include GPUs, CPUs, TPUS, and/or other processor types) and/or one or more HIL platforms 926 (e.g., which may include some or all of the components from the vehicle simulator component(s) 806, described herein).

A simulated environment 928 (e.g., which may be similar to the simulated environment 810 described herein) may be modeled by interconnected components including a simulation engine 930, an AI engine 932, a global illumination (GI) engine 934, an asset data store(s) 936, and/or other components. In some examples, these component(s) may be used to model a simulated environment (e.g., a virtual world) in a virtualized interactive platform (e.g., similar to a massive multiplayer online (MMO) game environment). The simulated environment may further include physics, traffic simulation, weather simulation, and/or other features and simulations for the simulated environment. GI engine 934 may calculate GI once and share the calculation with each of the nodes 918(1)-918(N) and 920(1)-920(N) (e.g., the calculation of GI may be view independent). The simulated environment 928 may include an AI universe 922 that provides data to GPU platforms 924 (e.g., GPU servers) that may create renderings for each sensor of the vehicle (e.g., at the virtual sensor/codec(s) 918 for a first virtual object and at the virtual sensor codec(s) 920 for a second virtual object). For example, the GPU platform 924 may receive data about the simulated environment 928 and may create sensor inputs for each of 918(1)-918(N), 920(1)-920(N), and/or virtual sensor/codec pairs corresponding to other virtual objects (depending on the embodiment). In examples where the virtual objects are simulated using HIL objects, the sensor inputs may be provided to the vehicle hardware 801 which may use the software stack(s) 803 to perform one or more operations and/or generate one or more commands, such as those described herein. In some examples, as described herein, the virtual sensor data from each of the virtual sensors may be encoded using a codec prior to being used by (or transmitted to) the software stack(s) 803. In addition, in some examples, each of the sensors may be executed on its own GPU within the GPU platform 924, while in other examples, two or more sensors may share the same GPU within the GPU platform 924.

The one or more operations or commands may be transmitted to the simulation engine 930 which may update the behavior of one or more of the virtual objects based on the operations and/or commands. For example, the simulation engine 930 may use the AI engine 932 to update the behavior of the AI agents as well as the virtual objects in the simulated environment 928. The simulation engine 930 may then update the object data and characteristics (e.g., within the asset data store(s) 936), may update the GI (and/or other aspects such as reflections, shadows, etc.), and then may generate and provide updated sensor inputs to the GPU platform 924. This process may repeat until a simulation is completed.

### Example Autonomous Vehicle

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to enable the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to enable autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LIDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation enabling any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 1004 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LIDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1012 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to enable communication with peripherals, audio codecs, power management, and/or other devices. The SoC(s) 1004 may be used to process data from cameras (e.g., connected over Gigabit Multimedia Serial Link and Ethernet), sensors (e.g., LIDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LIDAR sensor(s) 1064. The LIDAR sensor(s) 1064 may be used for object and pedestrian detection, emergency braking, collision avoidance, and/or other functions. The LIDAR sensor(s) 1064 may be functional safety level ASIL B. In some examples, the vehicle 1000 may include multiple LIDAR sensors 1064 (e.g., two, four, six, etc.) that may use Ethernet (e.g., to provide data to a Gigabit Ethernet switch).

In some examples, the LIDAR sensor(s) 1064 may be capable of providing a list of objects and their distances for a 360-degree field of view. Commercially available LIDAR sensor(s) 1064 may have an advertised range of approximately 1000 m, with an accuracy of 2 cm-3 cm, and with support for a 1000 Mbps Ethernet connection, for example. In some examples, one or more non-protruding LIDAR sensors 1064 may be used. In such examples, the LIDAR sensor(s) 1064 may be implemented as a small device that may be embedded into the front, rear, sides, and/or corners of the vehicle 1000. The LIDAR sensor(s) 1064, in such examples, may provide up to a 120-degree horizontal and 35-degree vertical field-of-view, with a 200 m range even for low-reflectivity objects. Front-mounted LIDAR sensor(s) 1064 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1000. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LIDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both 12V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084(H) (collectively referred to herein as GPUs 1084), PCIe switches 1082(A)-1082(H) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161(N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A. A method comprising: obtaining input data representative of one or more objects in a virtual environment; generating, using one or more language models and based at least on the input data, one or more tokens representative of one or more portions of code for rendering the one or more objects in the virtual environment; generating, using the one or more tokens and based at least on one or more syntax rules, text representing the code; and causing, using a simulation system and based at least on the text representing the code, the one or more objects to be rendered in the virtual environment.
B. The method of paragraph A, wherein the one or more language models are updated, at least, by: applying, to the one or more language models, at least: a training dataset including one or more examples of code executable by the simulation system; and training data representing one or more user requests; generating, using the one or more language models and based at least on the training data and the training dataset, output data representing one or more lines of code; and updating one or more parameters of the one or more language models based at least on one or more differences between the one or more lines of code and one or more ground truth lines of code executable by the simulation system.
C. The method of any one of paragraphs A-B, wherein the input data includes audio data representing speech, the method further comprising: generating, based at least on processing the audio data using one or more automatic speech recognition (ASR) systems, text data corresponding to the speech; and applying the text data to the one or more language models, wherein the generating of the one or more tokens is based at least on the one or more language models processing the text data.
D. The method of any one of paragraphs A-C, wherein the input data includes text data, the text data obtained using a graphical user interface presented on a user device, the graphical user interface associated with the simulation system that is rendering the virtual environment.
E. The method of any one of paragraphs A-D, further comprising: generating, using the one or more language models and based at least on the input data, one or more input tokens representative of the input data; and generating, using the one or more language models, one or more embeddings corresponding to the one or more input tokens, the one or more embeddings including one or more positional encodings, wherein the generating of the one or more tokens representative of the one or more portions of the code is based at least on the one or more embeddings and the one or more positional encodings.
F. The method of any one of paragraphs A-E, further comprising: obtaining, from one or more databases and based at least on analyzing the input data, one or more sources of information related to rendering objects in the virtual environment; and generating updated input data by adding the one or more sources of information to the input data, wherein the generating the one or more tokens is based at least on the updated input data.
G. A system comprising: one or more processors to: apply, to one or more language models, input data representative of one or more features of a simulation environment; generate, using the one or more language models and based at least on the input data, text representing code associated with rendering the one or more features of a simulation environment; and render, using a simulation system and based at least on the code, the one or more features of the simulation environment.
H. The system of paragraph G, wherein the one or more language models are updated at least by: applying, to the one or more language models, training data representing one or more user requests; generating, using the one or more language models and based at least on the training data, output data representing one or more lines of code; and updating one or more parameters of the one or more language models based at least on one or more differences between the one or more lines of code and one or more ground truth lines of code executable by the simulation system.
I. The system of any one of paragraphs G-H, wherein the simulation environment is rendered using one or more light transport simulation algorithms.
J. The system of any one of paragraphs G-I, wherein the input data includes audio data representing speech, the one or more processors further to: generate, based at least on processing the audio data using one or more automatic speech recognition (ASR) models, text data corresponding to the speech; and applying the text data to the one or more language models, wherein the generation of the text representing the code is based at least on the one or more language models processing the text data.
K. The system of any one of paragraphs G-J, wherein the input data includes text data, the text data obtained using a graphical user interface presented on a user device, the graphical user interface associated with the simulation system that is rendering the simulation environment.
L. The system of any one of paragraphs G-K, the one or more processors further to: generate, using the one or more language models and based at least on the input data, one or more tokens representative of one or more portions of the code for rendering the one or more features of the simulation environment, wherein the generation of the text representing the code is based at least on the one or more language models converting the one or more tokens into the text using one or more syntax rules.
M. The system of any one of paragraphs G-L, the one or more processors further to: generate, using the one or more language models and based at least on the input data, one or more input tokens representative of the input data; generate, using the one or more language models, one or more embeddings corresponding to the one or more input tokens; and update the one or more embeddings to include one or more positional encodings, wherein the generation of the one or more tokens representative of the one or more portions of the code is based at least on the one or more embeddings and the one or more positional encodings.
N. The system of any one of paragraphs G-M, the one or more processors further to: obtain, from one or more databases, one or more sources of information related to rendering features of the simulation environment; and generate updated input data that includes at least a portion of the information, wherein the application of the input data to the one or more language models comprises applying the updated input data to the one or more language models.
O. The system of any one of paragraphs G-N, wherein the one or more sources of information comprise one or more documents including one or more examples of code for rendering, in the simulation environment, at least one of: one or more simulated pedestrians; or one or more simulated vehicles.
P. The system of any one of paragraphs G-O, wherein the one or more features of the simulation environment comprise one or more simulated agents, and at least one of one or more behaviors or one or more attributes of the one or more simulated agents are defined using the code.
Q. The system of any one of paragraphs G-P, wherein the code includes one or more application programming interface (API) calls to one or more APIs for rendering the one or more features of the simulation environment.
R. The system of any one of paragraphs G-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing operations using one or more multi-modal language models; a system implementing one or more machine learning models as an inference microservice using one or more operating system (OS)-level virtualization packages; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.
S. One or more processors comprising: processing circuitry to generate, using one or more language models that process input data representative of a simulated environment, text representing one or more instructions that, when executed, cause a simulation system to update a representation of the simulated environment to include one or more simulated agents having one or more attributes corresponding to one or more first parameters indicated in the input data and one or more randomized attributes corresponding to one or more second parameters omitted from the input data, the simulated environment rendered by the simulation system using one or more light transport simulation algorithms.
T. The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using a large language model; a system for performing operations using one or more vision language models (VLMs); a system for performing operations using one or more multi-modal language models; a system implementing one or more machine learning models as an inference microservice using one or more operating system (OS)-level virtualization packages; a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

What is claimed is:

1. A method comprising:
obtaining input data indicating one or more objects for a virtual environment;
generating, using one or more language models and based at least on the input data, one or more tokens representative of one or more portions of code for rendering the one or more objects in the virtual environment;
generating, using the one or more tokens and based at least on one or more syntax rules, text representing the code; and
causing, using a simulation system and based at least on the text representing the code, the one or more objects to be rendered in the virtual environment.

2. The method of claim 1, wherein the one or more language models are updated, at least, by:
applying, to the one or more language models, at least:
a training dataset including one or more examples of code executable by the simulation system; and
training data representing one or more user requests;
generating, using the one or more language models and based at least on the training data and the training dataset, output data representing one or more lines of code; and
updating one or more parameters of the one or more language models based at least on one or more differences between the one or more lines of code and one or more ground truth lines of code executable by the simulation system.

3. The method of claim 1, wherein the input data includes audio data representing speech, the method further comprising:
generating, based at least on processing the audio data using one or more automatic speech recognition (ASR) systems, text data corresponding to the speech; and
applying the text data to the one or more language models,
wherein the generating of the one or more tokens is based at least on the one or more language models processing the text data.

4. The method of claim 1, wherein the input data includes text data, the text data obtained using a graphical user interface presented on a user device, the graphical user interface associated with the simulation system that is rendering the virtual environment.

5. The method of claim 1, further comprising:
generating, using the one or more language models and based at least on the input data, one or more input tokens representative of the input data; and
generating, using the one or more language models, one or more embeddings corresponding to the one or more input tokens, the one or more embeddings including one or more positional encodings,
wherein the generating of the one or more tokens representative of the one or more portions of the code is based at least on the one or more embeddings and the one or more positional encodings.

6. The method of claim 1, further comprising:
obtaining, from one or more databases and based at least on analyzing the input data, one or more sources of information related to rendering objects in the virtual environment; and
generating updated input data by adding the one or more sources of information to the input data,
wherein the generating the one or more tokens is based at least on the updated input data.

7. A system comprising:
one or more processors to:
apply, to one or more language models, input data indicating one or more features of a simulation environment;
generate, using the one or more language models and based at least on the input data, text representing code associated with rendering the one or more features of a simulation environment; and
render, using a simulation system and based at least on the code, the one or more features of the simulation environment.

8. The system of claim 7, wherein the one or more language models are updated at least by:
applying, to the one or more language models, training data representing one or more user requests;
generating, using the one or more language models and based at least on the training data, output data representing one or more lines of code; and
updating one or more parameters of the one or more language models based at least on one or more differences between the one or more lines of code and one or more ground truth lines of code executable by the simulation system.

9. The system of claim 7, wherein the simulation environment is rendered using one or more light transport simulation algorithms.

10. The system of claim 7, wherein the input data includes audio data representing speech, the one or more processors further to:
generate, based at least on processing the audio data using one or more automatic speech recognition (ASR) models, text data corresponding to the speech; and
applying the text data to the one or more language models,
wherein the generation of the text representing the code is based at least on the one or more language models processing the text data.

11. The system of claim 7, wherein the input data includes text data, the text data obtained using a graphical user interface presented on a user device, the graphical user interface associated with the simulation system that is rendering the simulation environment.

12. The system of claim 7, the one or more processors further to:
generate, using the one or more language models and based at least on the input data, one or more tokens representative of one or more portions of the code for rendering the one or more features of the simulation environment,
wherein the generation of the text representing the code is based at least on the one or more language models converting the one or more tokens into the text using one or more syntax rules.

13. The system of claim 12, the one or more processors further to:
generate, using the one or more language models and based at least on the input data, one or more input tokens representative of the input data;
generate, using the one or more language models, one or more embeddings corresponding to the one or more input tokens; and
update the one or more embeddings to including one or more positional encodings,
wherein the generation of the one or more tokens representative of the one or more portions of the code is based at least on the one or more embeddings and the one or more positional encodings.

14. The system of claim 7, the one or more processors further to:
obtain, from one or more databases, one or more sources of information related to rendering features of the simulation environment; and
generate updated input data that includes at least a portion of the information,
wherein the application of the input data to the one or more language models comprises applying the updated input data to the one or more language models.

15. The system of claim 14, wherein the one or more sources of information comprise one or more documents including one or more examples of code for rendering, in the simulation environment, at least one of:
one or more simulated pedestrians; or
one or more simulated vehicles.

16. The system of claim 7, wherein:
the one or more features of the simulation environment comprise one or more simulated agents, and
at least one of one or more behaviors or one or more attributes of the one or more simulated agents are defined using the code.

17. The system of claim 7, wherein the code includes one or more application programming interface (API) calls to one or more APIs for rendering the one or more features of the simulation environment.

18. The system of claim 7, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system implementing one or more machine learning models as an inference microservice using one or more operating system (OS)-level virtualization packages;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to generate, using one or more language models that process input data associated with a simulated environment, text representing one or more instructions that, when executed, cause a simulation system to update a representation of the simulated environment to include one or more simulated agents having one or more attributes corresponding to one or more first parameters indicated in the input data and one or more randomized attributes corresponding to one or more second parameters omitted from the input data, the simulated environment rendered by the simulation system using one or more light transport simulation algorithms.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using a large language model;
a system for performing operations using one or more vision language models (VLMs);
a system for performing operations using one or more multi-modal language models;
a system implementing one or more machine learning models as an inference microservice using one or more operating system (OS)-level virtualization packages;
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
